(19) United States
(12) Patent Application Publication
(10) Pub. No.: US 2012/0276369 A1
(43) Pub. Date: Nov. 1, 2012

(54) PROTECTIVE COATINGS AND METHODS OF MAKING AND USING THE SAME

(75) Inventors: Naiyong Jing, Woodbury, MN (US); Feng Bai, Woodbury, MN (US)

(73) Assignee: 3M INNOVATIVE PROPERTIES COMPANY, Saint Paul, MN (US)

(21) Appl. No.: 13/509,618

(22) PCT Filed: Nov. 16, 2010
(86) PCT No.: PCT/US2010/056773

§ 371 Date: May 14, 2012

Related U.S. Application Data
(60) Provisional application No. 61/262,423, filed on Nov. 18, 2009.
(60) Provisional application No. 61/320,091, filed on Apr. 1, 2010.
(60) Provisional application No. 61/390,905, filed on Oct. 7, 2010.

(51) Int. Cl. B32B 5/16; B05D 5/06; B82Y 40/00

(52) U.S. Cl. 428/331; 427/162; 977/892

(57) ABSTRACT

Protective coatings are formed on a reflective surface of a substrate by depositing an aqueous coating composition including dispersed silica-containing nanoparticles; and removing at least a portion of the aqueous phase. In some embodiments, the aqueous coating composition includes an acid having a pKa of <3.5 in an amount effective to produce a pH of less than 5. In other embodiments, the aqueous coating composition includes at least one dispersed (co)polymer, which in some embodiments, forms core-shell particle having a dispersed (co)polymer core surrounded by a shell consisting essentially of silica nanoparticles. In some of these embodiments, the pH is at least 5. Also described are methods of making and using the coating compositions to impart soil and stain accumulation resistance and easy cleaning characteristics to light reflective substrates such as construction articles (e.g., roofing materials), light reflective surfaces (e.g. reflective films) and light transmissive surfaces (e.g., photovoltaic cells).

### CROSS REFERENCE TO RELATED APPLICATION

This application claims the benefit of U.S. Provisional Patent Application Nos. 61/262,423, filed Nov. 18, 2009, 61/320,091, filed Apr. 1, 2010, and 61/390,905 filed Oct. 7, 2010, the disclosures of which are incorporated by reference herein in their entirety.

### TECHNICAL FIELD

The present disclosure relates to protective coatings including silica-containing nanoparticles, coated articles bearing such protective coatings, and methods of making and using such protective coatings, particularly on reflective surfaces.

### BACKGROUND

It has recently become more desirable, for energy conservation purposes, to reflect solar energy from roofs and other exterior surfaces of buildings. Absorbed solar energy increases cooling energy costs in buildings. In addition, in densely populated areas, such as metropolitan areas, the absorption of solar energy increases ambient air temperatures. A primary absorber of solar energy is building roofs. It is not uncommon for ambient air temperature in metropolitan areas to be 10° F. (about 5.5° C.) or more warmer than in surrounding rural areas. This phenomenon is commonly referred to as the urban heat island effect. Reflecting solar energy rather than absorbing it can reduce cooling costs and thereby energy costs in buildings. In addition, reducing solar energy absorption can enhance the quality of life in densely populated areas by helping to decrease ambient air temperatures.

Solar energy reflection can be achieved by using metallic or metal-coated roofing materials. However, because the heat emittance of metallic or metal-coating roofing materials is low, such materials do not produce significant gains in energy conservation and reduced costs since such materials restrict radiant heat flow. Reflection of solar energy can also be accomplished by using white or light-colored roofs. However, such white or white-colored roofs are not well accepted in the marketplace for aesthetic reasons. Instead, darker roofs arc preferred. However, darker roofs by their very nature absorb a higher degree of solar energy and reflect less.

Additionally, although construction materials, and particularly roofing materials, may have sufficiently high solar energy reflectivity when they are installed, a variety of environmental factors tend to degrade that performance. Growth of micro biota, such as algae, lichen, and moss, is a common problem on roofs in many areas especially those where exposed surfaces are often damp. In other regions, the deposit of air borne materials such as soot is a primary contributor to reduced solar energy reflectivity. Furthermore, in some applications, photovoltaic devices or cells (i.e. solar panels or arrays) may be installed on the roof or other parts of the building, and the same environmental factors may act to degrade the electrical power generation capability of the solar cell, panel or array.

Recently, there have been many efforts to develop compositions that can be applied to the surface of a substrate (e.g., glass, metal, cement, masonry, wood, and polymers) to provide a beneficial protective layer with desirable properties such as one or more of easy cleaning, stain prevention, long lasting performance, soap scum deposit inhibition, and the like. However, many compositions developed for such applications rely on organic materials (e.g., volatile organic solvents) that can present environmental issues and/or involve complex application processes. Furthermore, problems relating to inadequate shelf-life continue to plague product developers of such compositions. Thus, for many products a tradeoff of attributes is typically struck between the desired performance attributes, environmental friendliness of the materials, satisfactory shelf-life, and ease of use by unskilled user.

### SUMMARY

In one aspect, the present disclosure describes a method of providing a coating to a substrate including contacting a light reflective surface of a substrate with an aqueous coating composition comprising water, silica nanoparticles having a mean particle diameter of 40 nanometers or less dispersed in the water, and an acid having a pKa of <3.5 in an amount effective to produce a pH of less than 5; and removing at least a portion of the water to provide a dried silica nanoparticle coating on the light reflective surface of the substrate.

In another aspect, the present disclosure describes a method of providing a coating to a substrate including contacting a light reflective surface of a substrate with an aqueous coating composition comprising 0.5 to 99 wt. % water, 0.1 to 20 wt. % silica nanoparticles having a mean particle diameter of 20 nm or less, 0.1 to 60 wt. % silica nanoparticles having a mean particle diameter of from 20 nm to 200 nm, wherein the concentration of silica nanoparticles is from 0.2 to 80 percent by weight of the total composition, an acid having a pKa of <3.5 in an amount effective to produce a pH of less than 5, and optionally, 0 to 20 wt. % of a tetraalkoxysilane, relative to the total amount of the silica nanoparticles; and removing at least a portion of the water to provide a dried silica nanoparticle coating on the light reflective surface of the substrate.

In a further aspect, the present disclosure describes a method of providing a coating to a substrate including contacting a light reflective surface of a substrate with an aqueous coating composition comprising an aqueous continuous liquid phase, an acid having a pKa of <3.5 in an amount effective to produce a pH of less than 5; and core-shell particles dispersed in the aqueous continuous liquid phase, each core-shell particle comprising a dispersed (co)polymer core surrounded by a shell consisting essentially of silica nanoparticles disposed on the dispersed (co)polymer core, wherein the silica nanoparticles have a volume average particle diameter of 100 nanometers or less; and removing at least a portion of the water to provide a coating of the dispersed (co)polymer and silica nanoparticles on the light reflective surface of the substrate.

In certain exemplary embodiments of the foregoing three aspects, the acid is selected from oxalic acid, citric acid, H₃PO₄, HCl, HBr, HI, HBrO₃, HNO₃, HClO4, H₂SO₄, CH₃SO₃H, CF₃SO₃H, CF₃CO₂H, and CH₃SO₂OH. In some exemplary embodiments, the pH of the coating composition is less than 3.

In an additional aspect, the present disclosure describes a method of providing a coating to a substrate including contacting a light reflective surface of a substrate with an aqueous coating composition comprising water, silica nanoparticles having a mean particle diameter of 40 nanometers or less dispersed in the water, and at least one dispersed (co)polymer, wherein the aqueous coating composition has a pH of at least 5; and removing at least a portion of the water to provide a dried coating of the dispersed (co)polymer and silica nanoparticles on the light reflective surface of the substrate. In certain such presently preferred embodiments, the pH of the coating composition is at least 6-10.

In some of the foregoing exemplary embodiments wherein the coating composition includes a dispersed (co)polymer, the weight ratio of a total amount of the silica nanoparticles in the composition to a total amount of the at least one dispersed (co)polymer in the composition is in a range of from 85:15 to 95:5. In certain of these exemplary embodiments, the dispersed (co)polymer comprises a film-forming thermoplastic (co)polymer, which may preferably comprise a polyurethane segment.

In any of the foregoing aspects, the aqueous coating composition may, in some exemplary embodiments, include no more than about 20% by weight of organic solvent. However, in certain exemplary presently preferred embodiments, the aqueous coating composition is substantially free of organic solvent. In further exemplary embodiments according to any of the foregoing, the aqueous coating composition further includes at least one miscible (co)polymer.

With respect to any of the foregoing aspects, the present disclosure also provides, in exemplary embodiments, methods in which the dried silica nanoparticle coating on the light reflective surface of the substrate increases the reflectivity of the surface. In certain exemplary embodiments, the dried silica nanoparticle coating on the light reflective surface of the substrate exhibits a static water contact angle of less than 50°. In other exemplary embodiments, the dried silica nanoparticle coating on the light reflective surface of the substrate is from about 50 to about 250 nm thick.

In further exemplary embodiments illustrating the foregoing aspects, the substrate includes at least one of glass, metal, wood, ceramic, stone, a (co)polymer, or combinations thereof. In additional exemplary embodiments, the substrate includes a (co)polymer selected from poly(vinyl chloride), polyolefins, polycarbonates, polyamides, polyimides, polystyrenes, polyurethanes, polyesters, poly(ethylene terephthalate) (PET), flame-treated PET, cellulose diacetate, cellulose triacetate, styrene-acrylonitrile copolymers, ethylene-propylene dimer rubbers, phenolic resins, and combinations thereof. In any of the foregoing embodiments, the substrate may be a painted surface. In other exemplary embodiments, the substrate is transparent. In one particular presently-preferred embodiment, the substrate comprises a photovoltaic cell.

In additional exemplary embodiments further illustrating the foregoing aspects, the concentration of the silica nanoparticles is from 0.1 to 20 percent by weight of the coating composition. In other exemplary embodiments, the coating composition further comprises a surfactant.

In another aspect, the present disclosure describes construction articles made by any of the foregoing methods. In one particular embodiment, the construction article is a roofing material. In certain exemplary embodiments, the construction article is a roofing material selected from a shingle, a roofing tile, a roofing panel, a roofing membrane, or a roof coating. In some presently preferred embodiments, the roofing material is a roof coating including at least one (co)polymer selected from a styrene-(meth)acrylic copolymer, a polyurethane (co)polymer, an ethylene-propylene dimer elastomer, a chlorinated polyethylene elastomer, a chlorosulfonated polyethylene elastomer, an acrylonitrile rubber, a poly(isobutylene) elastomer, a thermoplastic polyolefin elastomer, a polyvinyl chloride elastomer, or combinations thereof. In some particular presently preferred embodiments, the roof coating is white.

Exemplary embodiments according to the present disclosure may have certain surprising and unexpected advantages over the art. For example, in some exemplary embodiments, the coating compositions and methods disclosed herein may advantageously provide long lasting useful levels of protection from staining minerals and dust or dirt deposits when applied to common substrates having a hard, reflective surface; for example, those that may be useful as construction materials, particularly for use in exterior construction applications exposed to weather and the elements. Moreover, the compositions may be formulated to contain little or no volatile organic solvents, are typically easy to apply, and may exhibit extended shelf stability.

Various aspects and advantages of exemplary embodiments of the exemplary embodiments of the present disclosure have been summarized. The above Summary is not intended to describe each illustrated embodiment or every implementation of the exemplary embodiments of the present disclosure. The Drawings and the Detailed Description that follow more particularly exemplify certain preferred embodiments using the principles disclosed herein.

### BRIEF DESCRIPTION OF THE DRAWINGS

FIG. 1 is a schematic cross-sectional view of an exemplary article coated with an exemplary nanosilica-containing coating composition according to the present disclosure.

FIGS. 2A-2B are photomicrographs of an exemplary nanosilica-containing coating composition before and after, respectively, application of the coating composition to a substrate according to the present disclosure.

FIGS. 3A-3C illustrate exemplary uncoated urethane control substrates, and FIGS. 3D-3F illustrate anti-soiling properties of exemplary urethane substrates coated with exemplary nanosilica-containing coating compositions according to the present disclosure, after application of the anti-soiling test described herein.

FIGS. 4A-4B illustrate anti-soiling properties of exemplary polymeric substrates coated on the right half with an exemplary nanosilica-containing coating composition according to the present disclosure, as compared to the uncoated left half of the control substrate, after application of the anti-soiling test described herein.

FIGS. 5A-5B illustrate anti-soiling properties of exemplary polymeric substrates coated on the right half with an exemplary nanosilica-containing coating composition according to the present disclosure, as compared to the uncoated left half of the control polymeric substrate, after application of the anti-soiling test described herein.

FIGS. 6A-6F illustrate anti-soiling properties of exemplary glass substrates, an upper portion of each substrate being coated with exemplary nanosilica-containing coating compositions according to the present disclosure, and a lower portion of each substrate being an uncoated control, after application of the anti-soiling test described herein.

FIGS. 6G-6L illustrate anti-soiling properties of exemplary polyester (PET) (co)polymer film substrates, an upper portion of each substrate being coated with exemplary nanosilica-containing coating compositions according to the present disclosure, and a lower portion of each substrate being an uncoated control, after application of the anti-soiling test described herein.

FIG. 7A-7D illustrates anti-soiling properties of exemplary retro-reflective polymethylmethacrylate (PMMA) (co)polymer film substrate coated with an exemplary nanosilica-containing coating composition of the present disclosure, after application of the anti-soiling test described herein, wherein the top retro-reflective PMMA sheets (FIGS. 7A-7B) were coated with the exemplary nanosilica-containing coating composition, while the lower retro-reflective PMMA sheets (FIGS. 7C-7D) were not coated.

FIG. 8 illustrates anti-soiling properties of an exemplary glass substrate in the form of a photovoltaic solar cell after application of the anti-soiling test described herein, wherein a lower portion of the glass substrate was coated with an exemplary nanosilica-containing coating composition according to the present disclosure, and an upper portion of the glass substrate was an uncoated control.

FIG. 9A illustrates anti-soiling properties of an exemplary nanosilica-containing coating composition of the present disclosure applied to an exemplary polyvinyl chloride (PVC) (co)polymer film substrate after application of the Anti-soiling Test described herein, wherein a lower portion of the (co)polymer film substrate was coated with an exemplary nanosilica-containing coating composition according to the present disclosure, and an upper portion of the glass substrate was an uncoated control.

FIGS. 9B-9C illustrates anti-soiling properties of an exemplary nanosilica-containing coating composition of the present disclosure applied to an exemplary ceramic tile substrate after application of the Anti-soiling Test described herein, wherein the left two-thirds of each ceramic substrate was coated with an exemplary nanosilica-containing coating composition according to the present disclosure, and the right third of each ceramic substrate was an uncoated control.

FIG. 10 illustrates anti-soiling properties of the exemplary white roof coating substrate of Comparative Example 19 after exposure to the Substrate Conditioning Procedures and application of the Anti-soiling Test described herein.

FIG. 11 illustrates anti-soiling properties of the exemplary nanosilica-containing coating composition of the present disclosure applied to the exemplary white roof coating substrate of Example 135 after exposure to the Substrate Conditioning Procedures and application of the Anti-soiling Test described herein.

FIG. 12 illustrates anti-soiling properties of the exemplary white roof coating substrate of Comparative Example 20 after exposure to the Substrate Conditioning Procedures and application of the Anti-soiling Test described herein.

FIG. 13 illustrates anti-soiling properties of the exemplary white roof coating substrate of Comparative Example 21 after exposure to the Substrate Conditioning Procedures and application of the Anti-soiling Test described herein.

FIG. 14 illustrates anti-soiling properties of the exemplary nanosilica-containing coating composition of the present disclosure applied to the exemplary white roof coating substrate of Example 136 after exposure to the Substrate Conditioning Procedures and application of the Anti-soiling Test described herein.

### DETAILED DESCRIPTION

### Glossary

In this application:

the term “continuous” refers to covering the surface of the substrate with virtually no discontinuities or gaps in the areas where the gelled network is applied;

the term “(co)polymer” refers to a (co)polymer, which may be a homopolymer or a copolymer.

the term “direct solar reflectance” refers to the reflected fraction of the incident solar radiation received on a surface perpendicular to the axis of the radiation within the wavelength range of 300 to 2500 nm, as computed according to a modification of the ordinate procedure defined in ASTM Method G159;

the term “elastomeric roofing membrane” means a pre-manufactured flexible or semi-flexible sheet formed with non-vulcanized and/or vulcanized elastomers, such as ethylene-propylene diene monomer (EPDM) elastomers, poly(vinyl) chloride (PVC) elastomers, chlorinated polyethylene (CPE) elastomers, chlorosulfonated polyethylene (CSPE) elastomers, acrylonitrile-rubber (NBR) elastomers, polyisobutylene) (PIB) elastomers, thermoplastic polyolefin (TPO) elastomers, and the like;

the term “miscible solvent” refers to a solvent which mixes substantially homogenously with the other components of the coating composition, and which preferably is soluble in or dissolves in the coating composition;

the terms “(meth)acrylate” or “(meth)acrylic” refers to a chemical compound derived from one or more acrylic ester and/or methacrylic ester;

the term “nanoparticle” means a primary particle having a mean diameter of one micrometer (μm, that is 1,000 nm) or less. The primary particle size may be determined, for example, using scanning electron microscopy;

the term “network” refers to an aggregation or agglomeration of nanoparticles linked together to form a porous three-dimensional network.;

the term “polyurethane” includes any polymeric material that has at least one polyurethane segment;

the term “polyurethane segment” refers to at least two urethane and/or urea groups that are connected by an organic group;

the term “porous” refers to the presence of voids between the silica-containing nanoparticles created when the nanoparticles form a continuous coating;

the term “primary particle size” refers to the average size of non-agglomerated single particles of silica;

the term “single ply roofing” refers to a single layer elastomeric roofing membrane which may be ballasted, fully-adhered, and/or mechanically attached installations;

the term “shell” refers to an assembly of nonporous spherical silica particles disposed on and covering (e.g., densely covering) the surface of a (co)polymer core;

the term “substantially free of organic solvent” refers to a coating composition that contains one percent or less by weight of organic solvent, and includes a coating composition that contains no organic solvent;

the term “surfactant” as used herein describes molecules comprising hydrophilic (polar) and hydrophobic (non-polar) regions on the same molecule which are capable of reducing the surface tension of the coating solution; and

the term “transparent” means transmitting at least 85% of incident light in the visible spectrum (about 400-700 nm wavelength). Transparent substrates may be colored or colorless.

The term “white” means the absence of color as defined by the CIE LAB 1976 color scale.

Various exemplary embodiments of the disclosure will now be described with particular reference to the Drawings. Embodiments of the present disclosure may take on various modifications and alterations without departing from the spirit and scope of the disclosure. Accordingly, it is to be understood that the embodiments of the present disclosure are not to be limited to the following described exemplary embodiments, but is to be controlled by the limitations set forth in the claims and any equivalents thereof.

Thus, in some exemplary embodiments, the present disclosure describes a method of providing a coating to a substrate including contacting a light reflective surface of a substrate with an aqueous coating composition comprising water, silica nanoparticles having a mean particle diameter of 40 nanometers or less dispersed in the water, and an acid having a pKa of <3.5 in an amount effective to produce a pH of less than 5; and removing at least a portion of the water to provide a dried silica nanoparticle coating on the light reflective surface of the substrate.

In other exemplary embodiments, the present disclosure describes a method of providing a coating to a substrate including contacting a light reflective surface of a substrate with an aqueous coating composition comprising 0.5 to 99 wt. % water, 0.1 to 20 wt. % silica nanoparticles having a mean particle diameter of 20 nm or less, 0.1 to 60 wt. % silica nanoparticles having a mean particle diameter of from 20 nm to 200 nm, wherein the concentration of silica nanoparticles is from 0.2 to 80 percent by weight of the total composition, an acid having a pKa of <3.5 in an amount effective to produce a pH of less than 5, and optionally, 0 to 20 wt. % of a tetraalkoxysilane, relative to the total amount of the silica nanoparticles; and removing at least a portion of the water to provide a dried silica nanoparticle coating on the light reflective surface of the substrate.

In further exemplary embodiments, the present disclosure describes a method of providing a coating to a substrate including contacting a light reflective surface of a substrate with an aqueous coating composition comprising an aqueous continuous liquid phase, an acid having a pKa of <3.5 in an amount effective to produce a pH of less than 5; and core-shell particles dispersed in the aqueous continuous liquid phase, each core-shell particle comprising a dispersed (co)polymer core surrounded by a shell consisting essentially of silica nanoparticles disposed on the dispersed (co)polymer core, wherein the silica nanoparticles have a volume average particle diameter of 100 nanometers or less; and removing at least a portion of the water to provide a coating of the dispersed (co)polymer and silica nanoparticles on the light reflective surface of the substrate.

In certain exemplary embodiments of the foregoing embodiments, the acid is selected from oxalic acid, citric acid, H₃PO₄, HCl, HBr, HI, HBrO₃, HNO₃, HClO₄, H₂SO₄, CH₃SO₃H, CF₃SO₃H, CF₃CO₂H, and CH₃SO₂OH. In some exemplary embodiments, the pH of the coating composition is less than 3.

Unexpectedly, in some embodiments, these silica-containing nanoparticle coating compositions, when acidified, can be coated directly onto hydrophobic organic and inorganic substrates without either addition of organic solvents or surfactants, or beading (dewetting) of the coating on the substrate. The wetting properties of these inorganic nanoparticle aqueous dispersions on hydrophobic surfaces such as polyethylene terephthalate (PET) or polycarbonate (PC) is a function of the pH of the dispersions and the pKa of the acid. The coating compositions are coatable on hydrophobic organic substrates when they are acidified with HCl to a pH of about 2 to 3, and even to 5 in some embodiments. In contrast, the coating compositions bead up on the organic substrates at neutral or basic pH.

While not wishing to bound by any particular theory, it is believed that the agglomerates of the silica-containing nanoparticles are formed by through acid-catalyzed siloxane bonding in combination with protonated silanol groups at the nanoparticle surfaces and these agglomerates explain the coatability on hydrophobic organic surfaces, as these groups tend to be bonded, adsorbed, or otherwise durably attached to hydrophobic surfaces.

Light-scattering measurements on these acidified dispersion solutions indicate that these silica-containing nanoparticles do tend to agglomerate, providing (after coating and drying) three-dimensional porous networks of silica-containing nanoparticles where each nanoparticle appears to be firmly bonded to adjacent nanoparticles. Micrographs reveal such bonds as silica “necks” between adjacent particles which are created by the acid in the absence of silica sources such as tetraalkoxysilanes. Their formation is attributed to the catalytic action of strong acid in making and breaking siloxane bonds. Surprisingly, the acidified dispersions appear to be stable when the pH is in the range 2 to 4.

Light-scattering measurements showed that these agglomerated, acidified 5 nm or 4 nm silica-containing nanoparticles at a pH of about 2-3 and at about 10 wt. % concentration, retained the same size after more than a week or even more than a month. Such acidified silica nanoparticle dispersions would be expected to remain stable even much longer at lower dispersion concentrations.

In other exemplary embodiments, the present disclosure describes a method of providing a coating to a substrate including contacting a light reflective surface of a substrate with an aqueous coating composition comprising water, silica nanoparticles having a mean particle diameter of 40 nanometers or less dispersed in the water, and at least one dispersed (co)polymer, wherein the aqueous coating composition has a pH of at least 5; and removing at least a portion of the water to provide a dried coating of the dispersed (co)polymer and silica nanoparticles on the light reflective surface of the substrate. In certain exemplary presently preferred embodiments, the pH of the coating composition is at least 6, more preferably at least 7, even more preferably at least 8 or even at least 9, most preferably at least 10.

In some exemplary embodiments wherein the coating composition includes a dispersed (co)polymer, the weight ratio of a total amount of the silica nanoparticles in the composition to a total amount of the at least one dispersed (co)polymer in the composition is in a range of from 85:15 to 95:5. In certain of these exemplary embodiments, the dispersed (co)polymer comprises a film-forming thermoplastic (co)polymer, which may preferably comprise a polyurethane segment.

Articles Coated with Nanoparticle Coating Compositions

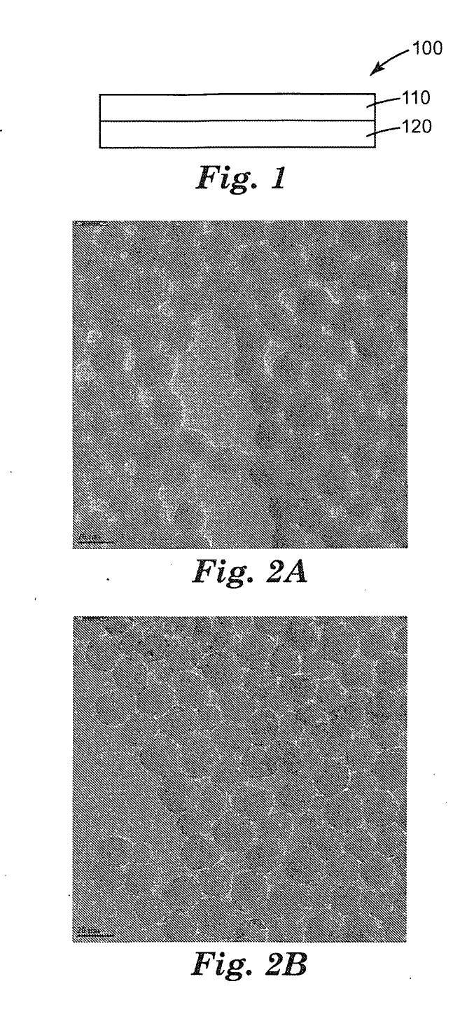

The present disclosure describes various construction articles made by applying the coating composition to a substrate using any of the foregoing methods. In one particular embodiment, the construction article is a roofing material. Referring now to FIG. 1, an article 100 comprises a TP1820 having a layer 110 disposed thereon. Layer 110 is formed by applying a composition according to the present disclosure to a surface of a substrate and at least partially removing the aqueous continuous liquid phase from the composition.

In general, coated construction articles of the present disclosure include a substrate which may be of virtually any construction, transparent to opaque, reflective, polymeric, glass, ceramic, or metal, having a flat, curved, or complex shape and having formed thereon a continuous network of agglomerated silica-containing nanoparticles. Nanosilica-containing coating compositions according to the present disclosure are useful, for example, to provide a protective coating to at least one surface of the substrate.

Substrates

Typically the substrate is in the form of a film, sheet, panel or pane of material and may be a part of an article such as an architectural glazing, decorative glass, or the like. The protective coatings of the present disclosure, may, optionally if desired, cover only a portion of the article. The substrate may be a construction article. Suitable substrates 120 may include, for example, any or all of the following construction materials:

Glass (e.g., architectural glass, including window glass, skylights, door panels, fiberglass, and the like, as well as optical elements such as, for example, lenses, mirrors, and photovoltaic cells), ceramic (e.g., ceramic tile, cement, stone, concrete, masonry, brick, porcelain, and the like), painted surfaces (e.g., walls, gypsum board, appliances, and the like), wood (e.g., wood for interior flooring), architectural siding (e.g., vinyl (PVC), metal (e.g., steel, galvanized steel, aluminum, and the like)), wood, cement (e.g., Hardy board), and the like), decking materials (e.g., wood, (co)polymer-wood composites, polypropylene, vinyl (PVC), high density polyethylene, and the like), decorative or protective polymeric films (e.g., polycarbonate, poly(vinyl chloride) (PVC), polypropylene, PET, flame-treated PET, polyurethane), decorative or protective polymeric films which are backed with pressure-sensitive adhesives, polymeric construction adhesives (e.g., thermosetting polymers, thermoplastics, polycarbonate, acrylics, polyolefins, polyurethanes, polyesters, polyamides, polyimides, phenolic resins, cellulose diacetate, cellulose triacetate, polystyrene, and styrene-acrylonitrile copolymers), sheet molding compounds, roofing materials, combinations thereof, and the like.

Transparent Substrates

Substrates to which the coating compositions of the present disclosure can be applied may, in some embodiments, have a surface which is transparent or translucent to light, particularly visible light. One particular application where the substrate surface is preferably transparent to visible light is in a photovoltaic device or cell (used in, e.g. a solar panel or an array of solar panels). Thus, in some exemplary embodiments where increased transmissivity may be desired, the substrate may preferably be transparent. Transparent substrates may be colored or colorless.

Preferred transparent substrates are polymeric, but glass may also be used. The polymeric substrates may comprise polymeric sheet, film, or molded material. Presently preferred transparent substrates include polyester (e.g., polyethylene terephthalate, polybutyleneterephthalate), polycarbonate, allyldiglycolcarbonate, polyacrylates, such as polymethylmethacrylate, polystyrene, polysulfone, polyethersulfone, homo-epoxy polymers, epoxy addition polymers with polydiamines, polydithiols, polyethylene copolymers, fluorinated surfaces, cellulose esters such as acetate and butyrate, glass, ceramic, organic and inorganic composite surfaces and the like, including blends and laminates thereof.

Non-Transparent Substrates

In other embodiments, the substrate need not be transparent. It has been found that exemplary coating compositions of the present disclosure provide easily cleanable surfaces to substrates such as flexible films used in graphics and signage. Flexible films may be made from polyesters such as PET or polyolefins such as PP (polypropylene), PE (polyethylene) and PVC (polyvinyl chloride) are particularly preferred.

The substrate can be formed into a film using conventional filmmaking techniques such as extrusion of the substrate resin into a film and optional uniaxial or biaxial orientation of the extruded film. The substrate can be treated to improve adhesion between the substrate and the hardcoat, using, e.g., chemical treatment, corona treatment such as air or nitrogen corona, plasma, flame, or actinic radiation. If desired, an optional tie layer can also be applied between the substrate and the coating composition to increase the interlayer adhesion. The other side of the substrate may also be treated using the above-described treatments to improve adhesion between the substrate and an adhesive. The substrate may be provided with graphics, such as words or symbols as known in the art.

In other embodiments, where increased hydrophilicity is desired, the substrate may be initially hydrophobic. The compositions may be applied to a wide variety of substrates by a variety of coating methods. As used herein, “hydrophilic” is used only to refer to the surface characteristics of the thermoplastic (co)polymer layer, i.e., that it is wet by aqueous solutions, and does not express whether or not the layer absorbs aqueous solutions. Accordingly, a thermoplastic (co)polymer layer may be referred to as hydrophilic whether or not the layer is impermeable or permeable to aqueous solutions. Surfaces on which drops of water or aqueous solutions exhibit a static water contact angle of less than 50° are referred to as “hydrophilic”. Hydrophobic substrates have a water contact angle of 50° or greater. Coatings described herein may increase the hydrophilicity of a substrate at least 10 degrees, preferably at least 20 degrees.

Reflective Substrates

Furthermore, in some exemplary embodiments, coating compositions of the present disclosure may be applied to a light reflective surface of a substrate in order to maintain a high degree of reflectivity, particularly when the substrate is used in exterior construction applications where it may be exposed to the elements. Suitable reflective substrates may include, for example, metal films or layers, (co)polymer films, (co)polymer films bearing a metallic coating, (co)polymer films having a retro-reflective surface, multilayer optical films, glass, glass bearing a metallic coating (e.g. a mirror), and the like. Particularly suitable reflective (co)polymer substrates include retro-reflective (co)polymer films sold under the trade name DIAMOND GRADE sheeting (available from 3M Company, St. Paul, Minn.), commercial graphics display films sold under the trade names SCOTCHCAL and SCOTCHPRINT (also available from 3M Company, St. Paul, Minn.), and multilayer optical mirror films as described, for example, in U.S. Pat. App. Pub. No. US 2009/0283133A1, and unpublished Patent App. No. 61/178,123, titled “Broadband Reflectors, Concentrated on Solar Power Systems, and Methods of Using the Same,” filed May 14, 2009.

Roofing Materials

In some presently preferred embodiments, the reflective substrate may be a construction material having a reflective surface (e.g. a roofing material). Maintenance of a high degree of reflectivity may be particularly important for roofing materials, in order to achieve energy conservation objectives (e.g. high solar reflectivity). Solar reflectivity values of at least 25% meet the present solar reflectivity standard set forth by the U.S. Environmental Protection Agency (EPA) under the program entitled “Energy Star”. The phrase solar reflectivity and direct solar reflectance are used interchangeably in the present application. The EPA permits manufacturers to use the designation “Energy Star” for those roofing products that meet certain energy specifications. This “Energy Star” designation is a desirable designation to place on roofing products.

In certain exemplary embodiments, the construction article is a roofing material selected from a shingle, a roofing tile, a roofing panel, a roofing membrane, or a roof coating.

For low-slope roofs where high reflectivity is important, the following non-limiting roofing materials are presently preferred:

polymeric roof coatings (e.g., acrylic, polyurethane, silicone, polyurea, polyester, poly(methyl)methacrylate, and the like) and white single-ply polymeric membranes (e.g., thermoplastic polyolefins (TPO's), polyvinyl chloride (PVC), Hypalon, ethylene-propylene dimer rubber (EPDM rubber), and the like). Additional low-slope roofing materials include Built-Up Asphalt (BUA), Modified Bitumen (Mod-Bit), Spray-Foam (SPF), EPDM (another single ply), and the like. If used as reflective roofing materials, the latter materials are typically used with a more reflective top coating.

In some presently preferred embodiments, the polymeric roof coating includes at least one (co)polymer selected from a styrene-(meth)acrylic copolymer, a polyurethane (co)polymer, an ethylene-propylene dimer elastomer, a chlorinated polyethylene elastomer, a chlorosulfonated polyethylene elastomer, an acrylonitrile rubber, a poly(isobutylene) elastomer, a thermoplastic polyolefin elastomer, a polyvinyl chloride elastomer, or combinations thereof.

In some particular presently preferred embodiments, the roof coating is white. Suitable white polymeric roof coatings are exemplified by the SCOTCHKOTE CSM and EC/UV liquid roof coating materials, more preferably, POLY-TECH CSM 658 and SCOTCHKOTE POLY-TECH UV, available from 3M Company, St. Paul, Minn.

For steep-slope roofs, the following non-limiting roofing materials are presently preferred:

Aggregate asphalt shingles (e.g. shingles containing inorganic mineral granules), clay and concrete tile, metal (both standing seam and architectural), wood shake, slate, synthetic (co)polymer variations of the foregoing (e.g. tiles, shakes, slate, and the like), and the like. If used as reflective roofing materials, these materials are typically used with a more reflective top coating.

In some exemplary embodiments, the roofing substrate is an inorganic and non-metallic aggregate material in granular form. Although the nanosilica coating composition may be placed on other roofing construction surfaces such as glass, clay or concrete tile, polymeric substances, concrete, rock, such construction surfaces may, but need not be, in granular form. In general, any liquid (co)polymer coating as described above can also be used to produce a reflective aggregate coating.

In some exemplary embodiments, the construction material includes a non-white construction surface comprising a coated substrate such as inorganic mineral granules for use in roofing that have enhanced solar reflectivity relative to conventional roofing granules. The enhanced reflectivity may be obtained by first providing a reflective primary or undercoating to the substrate granules and then providing a secondary coating over the undercoating with the secondary coating containing a non-white pigment. In some embodiments, the pigment may have enhanced reflectivity in the near-infrared (NIR) (700-2500 nm) portion of the solar spectrum.

Other exemplary embodiments of the present disclosure employ colored pigments that exhibit enhanced reflectivity in the NIR portion of the solar spectrum as compared to previous colorants. The NIR comprises approximately 50-60% of the sun's incident energy. Improved reflectivity in the NIR portion of the solar spectrum leads to significant gains in energy efficiency and such pigments are useful in some embodiments of the exemplary embodiments of the present disclosure.

Nanosilica Coating Compositions

In some exemplary embodiments, silica-containing nanoparticle dispersions of the present disclosure form a continuous network of silica-containing nanoparticle agglomerates on a surface of the substrate upon acidification with an acid having a pKₐ of less than 5, more preferably less than 4, even more preferably less than 3 or even less than 2.5 or even 1.

FIG. 2A shows an exemplary coated article of the present disclosure. As can be seen, the individual silica-containing nanoparticles are linked to adjacent silica-containing nanoparticles to form a network. The coating appears uniform. In essence, the particles are sintered at room temperature. In contrast, FIG. 2B shows a coating from ethanol at a basic pH. The coating appears non-uniform and the individual particles are not linked to the adjacent particles. There is no apparent sintering of the particles at room temperature.

Preferably, the dried coating composition forms a porous network which has a porosity of about 25 to 45 volume percent, more preferably about 30 to 40 volume percent, when dried. In some embodiments the porosity may be higher. Porosity may be calculated from the refractive index of the coating according to published procedures such as in W. L. Bragg, A. B. Pippard, Acta Crystallographica, volume 6, page 865 (1953). Coating layer thicknesses may vary considerably, in some embodiments as high as a few microns or mils thick, depending on the application, such as for easy-clean of removal of undesired particulates, rather than antireflection. The mechanical properties of the dried coating composition may be expected to be improved when the coating thickness is increased.

In other exemplary embodiments wherein the nanosilica coating composition includes a dispersed (co)polymer, it may be desirable to maintain the pH of the coating composition at a value of at least 5, more preferably at least 6, even more preferably at least 7, more preferably still at least 8 or even at least 9, most preferably at least 10.

Silica-Containing Nanoparticles

The silica-containing nanoparticles used in preparing the coating compositions of the present disclosure may include submicron size silica nanoparticles dispersed in an aqueous or in a water/organic solvent mixture and having and average primary particle diameter of 40 nanometers or less, preferably 20 nanometers or less, and more preferably 10 nanometers or less. The average particle size may be determined using transmission electron microscopy. The silica-containing nanoparticles are preferably not surface modified.

The smaller nanoparticles, those of 20 nanometers or less, generally provide better coatings, when acidified, without the need for additives such as tetralkoxysilanes, surfactants or organic solvents. Further, the nanoparticles generally have a surface area greater than about 150 m²/gram, preferably greater than 200 m²/gram, and more preferably greater than 400 m²/gram. The particles preferably have narrow particle size distributions, that is, a polydispersity of 2.0 or less, preferably 1.5 or less. If desired, larger silica particles may be added, in amounts that do not deleteriously decrease the coatability of the composition on a selected substrate, and do not reduce the transmissivity and/or the hydrophilicity.

Suitable inorganic silica sols in aqueous media are well known in the art and available commercially. Silica sols in water or water-alcohol solutions are available commercially under such trade names as LUDOX (manufactured by E.I. duPont de Nemours and Co., Inc., Wilmington, Del., USA), NYACOL (available from Nyacol Co., Ashland, Mass.) or NALCO (manufactured by Ondea Nalco Chemical Co., Oak Brook, Ill., USA). One useful silica sol is NALCO 2326 available as a silica sol with mean particle size of 5 nanometers, pH 10.5, and solid content 15% by weight. Other commercially available silica-containing nanoparticles include “NALCO 1115” and “NALCO 1130,” commercially available from NALCO Chemical Co., “Remasol SP30,” commercially available from Remet Corp., and “LUDOX SM,” commercially available from E. I. Du Pont de Nemours Co., Inc.

Silica sols comprising non-spherical silica nanoparticles are also useful and are available as, for example, string-of-pearls-shaped “SNOWTEX PS” and elongated “SNOWTEX UP”, both of which are available from Nissan Chemical America Corporation, Houston, Tex.

Non-aqueous silica sols (also called silica organosols) may also be used and are silica sol dispersions wherein the liquid phase is an organic solvent, or an aqueous organic solvent. In the practice of this present disclosure, the silica sol is chosen so that its liquid phase is compatible with the emulsion, and is typically aqueous or an aqueous organic solvent. However, it has been observed that sodium stabilized silica-containing nanoparticles should first be acidified prior to dilution with an organic solvent such as ethanol. Dilution prior to acidification may yield poor or non-uniform coatings. Ammonium stabilized silica-containing nanoparticles may generally be diluted and acidified in any order.

Mixtures of Two Sizes of Silica-Containing Nanoparticles

In some exemplary embodiments, larger silica nanoparticles may be added, in amounts that do not reduce the wetting properties of the nanosilica coating composition. In some embodiments, the reflectivity and/or soil resistance of the substrate may be improved by adding larger silica particles to the coating composition. These additional silica particles generally have an average primary particle size of greater than 20 to 200 nanometers, preferably 30 to 150 nanometers, more preferably 40-100 nm; and may be used in ratios of 0.2:99.8 to 99.8:0.2, relative to the weight of the silica-containing nanoparticles of less than 40 nanometers. Larger particles are preferably used in a ratio (to smaller particles) of 1:9 to 9:1. Generally the total weight of silica particles (i.e. the total of <40 nm and larger silica particles) in the composition is 0.1 to 40 wt. %, preferably 1 to 20 wt. %, most preferably 2 to 10 wt. %.

Core/Shell Silica-Containing Nanoparticles

Nonporous spherical silica particles in aqueous media (sols) are well known in the art and are available commercially; for example, as silica sols in water or aqueous alcohol solutions under the trade designations LUDOX from E. I. du Pont de Nemours and Co., Wilmington, Del.), NYACOL from Nyacol Co. of Ashland, Mass., or NALCO from Nalco Chemical Co. of Naperville, Ill. One useful silica sol with a volume average particle size of 5 nm, a pH of 10.5, and a nominal solids content of 15 wt. %, is available as NALCO 2326 from Nalco Chemical Co. Other useful commercially available silica sols include those available as NALCO 1115 and NALCO 1130 from Nalco Chemical Co., as REMASOL SP30 from Remet Corp. of Utica, N.Y., and as LUDOX SM from E. I. du Pont de Nemours and Co.

Non-aqueous spherical silica sols are spherical silica sol dispersions wherein the liquid phase is an organic solvent. Typically, the silica sol is chosen so that its liquid phase is compatible with the remaining components of the continuous liquid phase. Typically, sodium-stabilized nonporous spherical silica particles should first be acidified prior to dilution with an organic solvent such as ethanol, as dilution prior to acidification may yield poor or non-uniform coatings. Ammonium-stabilized silica-containing nanoparticles may generally be diluted and acidified in any order.

The dispersed (co)polymer core may comprise any (co)polymer, typically one that can be prepared as a latex, more typically as an alkaline pH stable latex. Exemplary (co)polymers include acrylic polymers, styrenic polymers, vinyl acetate-ethylene copolymers, polyvinyl acetate, styrene-butadiene rubbers, polyurethanes (including urethane-acrylic polymers), polyesters, and polyamides. Preferably, the (co)polymer is a film-forming (co)polymer. The (co)polymer may be thermosetting or thermoplastic. Preferably, the (co)polymer comprises a polyurethane segment as in the case of a polyurethane or a urethane-acrylic (co)polymer (which typically has polyurethane and polyacrylic segments). Suitable (co)polymer latexes and methods for making them are widely known in the art, and many are commercially available.

Examples of commercially available (co)polymer latexes include those aqueous aliphatic polyurethane emulsions available as NEOREZ R-960, NEOREZ R-967, NEOREZ R-9036, and NEOREZ R-9699 from DSM NeoResins, Inc. of Wilmington, Mass.; aqueous anionic polyurethane dispersions available as ESSENTIAL CC4520, ESSENTIAL CC4560, ESSENTIAL R4100, and ESSENTIAL R4188 from Essential Industries, Inc. of Merton, Wis.; polyester polyurethane dispersions available as SANCURE 843, SANCURE 898, and SANCURE 12929 from Lubrizol, Inc. of Cleveland, Ohio; an aqueous aliphatic self-crosslinking polyurethane dispersion available as TURBOSET 2025 from Lubrizol, Inc.; and an aqueous anionic, co-solvent free, aliphatic self-crosslinking polyurethane dispersion, available as BAYHYDROL PR240 from Bayer Material Science, LLC of Pittsburgh, Pa.

Combinations of polymers may be included in the (co)polymer core. For example, an individual (co)polymer core may comprise two or more polymers. Further, the composition may contain two types of (co)polymer cores, each comprising a different type of (co)polymer, for example, as would be obtained by mixing an acrylic latex and a polyurethane latex. Typically, the particles in the (co)polymer latexes are substantially spherical in shape. Typically, the (co)polymer core comprises one or more water-insoluble polymers, although this is not a requirement.

Useful (co)polymer particle sizes include those typical of latexes and other dispersions or emulsions. Typical (co)polymer particle sizes are in a range of from about 0.01 micrometers to 100 micrometers, preferably in a range of from 0.01 to 0.2 micrometers, although this is not a requirement.

Core-shell particles may typically be prepared from an alkaline pH stable (co)polymer particle dispersion and an alkaline spherical silica sol. Typically, such (co)polymer particle dispersions become unstable upon acidification to pH values of 5 or less. Accordingly, it is unexpected that by adding the alkaline nonporous spherical silica sol to the aqueous (co)polymer particle dispersion, with acidification, results in core-shell particles that are stable at low pH values.

To achieve shell formation the nonporous spherical silica particles should typically be smaller than the (co)polymer core, although this is not a requirement. For example, the volume average particle diameter (D50) of the (co)polymer particles may be on the order of at least 3 times greater than the volume average particle diameter (D50) of the spherical silica particles. More typically, the volume average particle diameter of the (co)polymer particles should typically be on the order of at least 5 times, at least 10 times, or even at least 50 times greater than the volume average particle diameter of the spherical silica particles. For typical (co)polymer particle sizes, a weight ratio of the nonporous spherical silica particles to the one or more (co)polymer particles is in a range of from 30:70 to 97:3, preferably 80:20 to 95:5, and more preferably 85:15 to 95:5.

Without wishing to be bound by theory, it is believed that during gradual acidification of such a dispersion of (co)polymer particles (e.g., latex particles) and nonporous spherical silica particles in the aqueous liquid vehicle, the nonporous spherical silica particles deposit on the surface of the (co)polymer latex particles, eventually in sufficient quantity to form a shell (typically at least a monolayer of the spherical silica particles) that serves to stabilize the dispersion and reduce or prevent agglomeration and precipitation of the (co)polymer particles. It is further believed that upon addition of base to raise the pH that the nonporous spherical silica particles dissociate from the (co)polymer latex particles and regenerate a mixture of the two types of particles.

Each core-shell particle comprises a (co)polymer core surrounded by a shell that consists essentially of nonporous spherical silica particles disposed on the (co)polymer core. Accordingly, the shell is substantially free of other particulate matter, and especially acicular silica particles.

In addition, to facilitate coating, some exemplary core/shell nanosilica/dispersed (co)polymer coating compositions according to the present disclosure preferably have a pH of less than 5, more preferably less than 4, and more still preferably less than 3 or even 2 or 1. To facilitate handling, the coating compositions preferably have a pH of at least 1, more preferably at least 2, 3, or 4. In some embodiments, for example, those involving an acid sensitive substrate, it may be preferable to adjust the pH to a value of from about 5 to about 7.5, although this may tend to disrupt the core-shell particle structure.

Optional Organic Binder

The coating composition may include an organic binder. For example, the coating composition may include a dispersed (co)polymer, for example, an emulsion (co)polymer latex such as a dispersed aliphatic polyurethane. Suitable dispersed (co)polymer binders are described above as being suitable for use in preparing core/shell nanosilica/dispersed (co)polymer coating compositions. The weight ratio of the silica particles to the dispersed (co)polymer binder is generally at least about 1:1, and in some specific examples it ranges from 2:1 to 9:1; 4:1 to 8:1, 5:1 to 7:1 or even 6:1.

In some exemplary embodiments wherein the nanosilica coating composition includes a dispersed (co)polymer, it may be desirable to maintain the pH of the coating composition at a value of at least 5, more preferably at least 6, even more preferably at least 7, more preferably still at least 8 or even at least 9, most preferably at least 10.

In further exemplary embodiments according to any of the foregoing, the aqueous coating composition further includes at least one miscible (e.g. dissolved or soluble) (co)polymer, for example, a water soluble (co)polymer such as an acrylic acid or acrylamide (co)polymer, or a salt thereof. The weight ratio of the silica particles to the miscible (co)polymer binder is generally at least about 1:1, more preferably at least about 5:1, even more preferably at least about 6:1. In some specific examples the weight ratio of the silica particles to the miscible (co)polymer binder ranges from 2:1 to 9:1; 4:1 to 8:1, 5:1 to 7:1 or even 6:1.

Aqueous Continuous Liquid Phase

Compositions according to the present disclosure comprise an aqueous continuous liquid phase. The aqueous continuous liquid phase comprises at least 5 wt. % of water; for example, the aqueous continuous liquid phase may comprise at least 50, 60, 70, 80, or 90 wt. % of water, or more.

Optional Organic Solvent

While the aqueous continuous liquid phase is preferably essentially free of (i.e., contains less than 0.1 wt. % of based on the total weight of the aqueous continuous liquid phase) organic solvents, especially volatile organic solvents, organic solvents may optionally be included in a minor amount if desired. Thus, in any of the foregoing embodiments, the aqueous coating composition may include no more than about 20% by weight of organic solvent, more preferably no more than 15 wt. % of organic solvent, even more preferably no more than 10 wt. % of organic solvent, or even no more than 5 wt. % of organic solvent. Furthermore, in certain exemplary presently preferred embodiments, the aqueous coating composition is substantially free of organic solvent, containing 1 wt. % or less organic solvent, or even no organic solvent.

If present, the organic solvents should preferably be water-miscible, or at least water-soluble in the amounts in which they are used, although this is not a requirement. Examples of organic solvents include acetone and lower molecular weight ethers and/or alcohols such as methanol, ethanol, isopropanol, n-propanol, glycerin, ethylene glycol, triethylene glycol, propylene glycol, ethylene glycol monomethyl or monoethyl ether, diethylene or dipropylene glycol methyl or ethyl ether, ethylene or propylene glycol dimethyl ether, and triethylene or tripropylene glycol monomethyl or monoethyl ether, n-butanol, isobutanol, s-butanol, t-butanol, and methyl acetate.

Although aqueous organic solvent based coatings of nanoparticle silica dispersions have been described, such mixtures of water and an organic solvents typically suffer from differential evaporation rates that result in continuously changing composition of the liquid phase, which consequently changes the coating properties; resulting in poor uniformity and defects. Although surfactants may help the wetting property of dispersions, they may interfere with interparticle and interfacial substrate adhesion, and may produce nonuniform and defect-containing coatings.

pH Adjusting Agents

Acids

Some of the exemplary coating compositions may be advantageously acidified to the desired pH level with an acid having a pKₐ of less than 5, preferably less than 2.5, and more preferably less than 1. Useful acids include both organic and inorganic acids such as, for example, oxalic acid, citric acid, benzoic acid, acetic acid, methoxyacetic acid, formic acid, propionic acid, benzenesulfonic acid, H₂SO₃, H₃PO₄, HCl, HBr, HI, HBrO₃, HNO₃, HClO₄, H₂SO₄, CH₃SO₃H, CF₃SO₃H, CF₃CO₂H, and CH₃OSO₃H. Preferred acids include HCl, H₂SO₄, and H₃PO₄.

Combinations of organic and inorganic acids may also be used. In some embodiments one may use a mixture of acids comprising those having a pKa ≦3.5 (preferably <2.5, most preferably less than 1) and minor amounts of other acids having pKa's >0. Using weaker acids having a pKₐ of greater than 4-5 may not result in a uniform coating having the desirable properties such as transmissivity, cleanability and/or durability. In particular, coating compositions formed using weaker acids, for example, acetic acid, may bead up on the surface of a substrate.

In certain exemplary embodiments, the coating composition preferably contains sufficient acid to provide a pH of less than 5, preferably less than 4, most preferably less than 3. In some embodiments, it has been found that the pH of the coating composition can be adjusted to pH 5-6 after reducing the pH to less than 5. This allows one to coat more pH sensitive substrates.

Bases

In certain exemplary embodiments wherein the nanosilica coating composition includes a dispersed (co)polymer, it may be desirable to maintain the pH of the coating composition at a value of at least 5, more preferably at least 6, even more preferably at least 7, more preferably still at least 8 or even at least 9, most preferably at least 10. Some of the exemplary coating compositions may be advantageously adjusted to the desired pH level by addition of a base to the coating composition. Suitable bases are known in the art, including, for example, ammonium hydroxide, and various alkali metal and/or alkaline metal hydroxides, including without limitation lithium hydroxide, sodium hydroxide, potassium hydroxide, magnesium hydroxide, calcium hydroxide, and the like.

Optional Components of the Coating Composition

Tetraalkoxy coupling agents, such as tetraethylorthosilicate (TEOS) and oligomeric forms, such as alkyl polysilicates (e.g. poly(diethoxysiloxane)), may be useful to improve binding between silica-containing nanoparticles upon drying the coating composition. The amount of such coupling agents included in the coating composition should be limited in order to prevent degradation of the shelf stability of the coating composition or performance properties of the coating. The optimal amount of coupling agent is determined experimentally and is dependent on the coupling agent's identity, molecular weight and refractive index. The coupling agent(s), when present, are typically added to the composition at levels of 0.1 to 20 wt. % of the silica nanoparticle concentration, and more preferably about 1 to 15 wt. % of the silica-containing nanoparticles.

In order to uniformly coat the composition onto a hydrophobic substrate from an aqueous system it may be desirable to increase the surface energy of the substrate and/or reduce the surface tension of the coating composition. The surface energy may be increased by oxidizing the substrate surface prior to coating using corona discharge or flame treatment methods. These methods may also improve adhesion of the coating to the substrate. Other methods capable of increasing the surface energy of the article include the use of primers such as thin coatings of polyvinylidene chloride (PVDC). Alternatively, the surface tension of the coating composition may be decreased by addition of lower alcohols (C₁ to C₈). In some instances, however, in order to improve the coating hydrophilicity for desired properties and to ensure uniform coating of the article from an aqueous or hydroalcoholic solution, it may be beneficial to add a wetting agent, which is typically a surfactant.

Optional Surfactant

Compositions according to the present disclosure may optionally include at least one surfactant. Examples of useful surfactants include: anionic surfactants such as sodium dodecylbenzenesulfonate, dioctyl ester of sodium sulfosuccinic acid, polyethoxylated alkyl (C 12) ether sulfate, ammonium salt, and salts of aliphatic hydrogen sulfates; cationic surfactants such as alkyldimethylbenzylammonium chlorides and di-tallowdimethyl-ammonium chloride; nonionic surfactants such as block copolymers of polyethylene glycol and polypropylene glycol, polyoxyethylene (7) lauryl ether, polyoxyethylene (9) lauryl ether, and polyoxyethylene (18) lauryl ether; and amphoteric surfactants such as N-coco-aminopropionic acid. Silicone, and fluorochemical surfactants such as those available under the trade designation FLUORAD (available from 3M Company of St. Paul, Minn.) may also be used. If present, the amount of surfactant typically is in an amount of less than about 0.1 percent by weight of the composition, preferably between about 0.003 and 0.05 percent by weight of the composition. Particularly useful surfactants are disclosed in U.S. Pat. No. 6,040,053 (Scholz et al.).

For typical concentrations of silica-containing nanoparticles (e.g., about 0.2 to 20 percent by weight relative to the total coating composition) most surfactants comprise less than about 0.1 percent by weight of the coating composition, preferably between about 0.003 and 0.05 percent by weight.

Optional Biological Growth Inhibitor

In some embodiments, the coating composition may include a biological growth inhibitor or a self-cleaning component in or on the coating. In some embodiments, the biological growth inhibitor or self-cleaning component will be adjacent to the construction surface coating rather than being a constituent of the construction surface coating itself. In yet other embodiments, a biological growth inhibitor or a self-cleaning component will be present in both the coating and adjacent to the coated construction surface.

The composition may also optionally contain an antimicrobial agent. Many antimicrobial agents are commercially available. Examples include those available as: Kathon CG or LX available from Rohm and Haas Co. of Philadelphia, Pa.; 1,3-dimethylol-5,5-dimethylhydantoin; 2-phenoxyethanol; methyl-p-hydroxybenzoate; propyl-p-hydroxybenzoate; alkyldimethylbenzylammonium chloride; and benzisothiazolinone.

Impurities

In some embodiments, the compositions are free of various impurities including, for example, nonspherical silica particles, porous silica particles, and added crosslinkers (e.g., polyaziridines or orthosilicates). Accordingly, compositions according to the present disclosure may contain less than 0.1 wt. % or less than 0.01 wt. % of acicular silica particles, and, if desired, they may be free of acicular silica particles.

Coating Composition Preparation and Coating Methods

Compositions according to the present disclosure may be made by any suitable mixing technique. One useful technique includes combining an alkaline (co)polymer latex with an alkaline spherical silica sol of appropriate particle size, and then adjusting the pH to the final desired level.

Preferably, compositions according to the present disclosure are stable when stored in the liquid form, e.g., they do not gel, opacify, form precipitated or agglomerated particulates, or otherwise deteriorate significantly.

The compositions are preferably coated on the article using conventional coating techniques, such as brush, bar, roll, wipe, curtain, rotogravure, spray, or dip coating techniques. For ease and simplicity, a preferred method is to wipe the coating formulation on using a suitable woven or nonwoven cloth, sponge, or foam. Such application materials are preferably acid-resistant and may be hydrophilic or hydrophobic in nature, preferably hydrophilic. Another method to control final thickness and resultant appearance is to apply the coating using any suitable method and, after allowing a portion of the solvent to evaporate, to rinse off excess composition with a stream of water, while the substrate is still fully or substantially wetted with the composition.

Compositions according to the present disclosure are preferably applied to a substrate in a uniform average wet thickness varying from 0.5 to 50 micrometers, and more preferably 1 to 10 micrometer, in order to avoid visible interference color variations in the coating, although other thicknesses may also be used.

After coating the surface of the substrate, the resultant article is typically dried at ambient or warm temperatures without the need for high temperature heat, radiation or other curing method. In exemplary embodiments in which the substrate is not heat sensitive or subject to thermal degradation, the coating composition may be dried at temperatures of between 20 and 150° C., for example, in a recirculating oven. An inert gas may be circulated. The temperature may be increased further to speed the drying process, but care must be exercised to avoid damage to the substrate.

After the coating composition is applied to the substrate and dried, the coating comprises preferably from about 60 to 95 wt. % (more preferably from about 70 to 92 wt. %) of silica-containing nanoparticles (typically agglomerated), from about 0.1 to 20 wt. % (more preferably from about 10 to 25 wt. %) tetralkoxysilanes and optionally about 0 to 5 wt. % (more preferably from about 0.5 to 2 wt. %) surfactant, and up to about 5 wt. % (preferably 0.1 to 2 wt. %) wetting agent.

The optimal average dry coating thickness is dependent upon the particular composition that is coated, but in some exemplary embodiments, the average thickness of the dried coating composition is between 0.05 to 5 micrometers, preferably 0.05 to 1 micrometer; for example, as estimated from atomic force microscopy and/or surface profilometry. Above this range, the dry coating thickness variations typically cause optical interference effects, leading to visible iridescence (rainbow effect) of the dried coating which is particularly apparent on darker substrates. Below this range the dry coating thickness may be inadequate to confer sufficient durability for most coatings exposed to environmental wear.

Advantages of Nanoparticle Protective Coatings

In some exemplary embodiments, the coating composition may provide improved cleanability, and provides a tough, abrasion resistant layer that protects the substrate and the underlying substrate from damage from causes such as scratches, abrasion and solvents, and the like. By “cleanability” it is meant that the coating composition, when cured, provides oil and soil resistance to help prevent the coated article from being soiled by exposure to contaminants such as oils or adventitious dirt. The coating composition can also make the hard coat easier to clean if it is soiled, so only a simple rinse with water may be required to remove surface contaminants.

Thus, in some exemplary embodiments, compositions according to the present disclosure, when coated on a substrate and at least partially dried, provide improved cleanability by way of a reduced tendency to accumulate dirt and other contaminants. Furthermore, in some additional exemplary embodiments, coating compositions of the present disclosure may, when dried, provide a protective coating which is easier to clean by contacting with flowing water or a water spray to readily displace overlying contamination, thereby removing a substantial portion of the contamination from the coating. While not wishing to be bound by any particular theory, this water sheeting effect may allow road spray, snow, slush dirt, soap scum, and staining minerals in rainwater and rinse water to substantially sheet out and run off the substrate surface, which significantly reduces the amount and the localized concentration of contaminants that are deposited after the water dries.

Exemplary embodiments of coating compositions and methods of making and using such compositions are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. All contact angle reported in the Examples are static contact angles reported in degrees. In addition, the following abbreviations and materials are used in the Examples below:

### Materials:

### Substrates

TP1: An aluminum test panel having the following coatings: CORMAX 6EP e-coat, 708DM730 primer, 648DNO27 black base coat and Du Pont RK8014 clear coat, obtained from ACT Laboratories, Hillsdale, Mich.;

TP2: An aluminum test panel having the following coatings: CORMAX 6EP e-coat, 708DM730 primer, 648DNO27 white base coat and Du Pont RK8014 clear coat, obtained from ACT Laboratorie, Hillsdale, Mich.;

TP3: An aluminum test panel having the following coatings: PC8000 e-coat, 615S primer, Du Pont IMRON 6000 LOOO6H white base coat and Du Pont 3440S clear coat, obtained from ACT Laboratories, Hillsdale, Mich.;

TP4: A steel test panel having the following coatings: an unspecified automotive e-coat, 765224EH primer, 270AB921 black base coat, and Du Pont RK8148 clear coat, obtained from ACT Laboratories, Hillsdale, Mich.;

TP5: A poly(methyl methacrylate) test panel;

TP6: A polystyrene-fiberglass test panel;

TP7: Float glass from Cardinal Glass, Eden Prairie, Minn.;

TP8: Polyethylene terephthalate (PET) film available under the trade designation “MELINEX 618” from E.I. DuPont de Nemours & Co., Wilmington, Del., and having a thickness of 5.0 mils and a primed surface;

TP9: Polycarbonate (PC) film available under the tradenames LEXAN 8010 (0.381-mm), 8010SHC (1.0-mm) and OQ92 from GE Advanced Materials Specialty Film and Sheet, Pittsfield, Mass.);

TP10: BYNEL-3101, a polyethylene copolymer commercially available from E. I. DuPont de Nemours & Co., Wilmington, Del.;

TP 11: PELLATHENE 2363, a polyether-based polyurethane, available from Dow Chemical Co., Midland Mich.;

TP12: 3M SCOTCHCAL Luster Overlaminate 8519, a 1.25 mil 31.25 micrometer thick) polyvinyl chloride (PVC) film available from 3M Company, St. Paul, Minn.;

TP13: Perfluoropolyether (PFPE) on PC (Example 84) refers to a polycarbonate substrate having a perfluoropolyether coating thereon, prepared according to Example 1 of U.S. Pat. App. Pub. No. 2009/0025727 (Klun et al.), using as the top coating a solution of SHC-1200 containing 0.5 wt. % of Preparation 2;

TP14: Polyurethane roof coating material, SCOTCHKOTE POLY-TECH UV, available from 3M Company, St. Paul, Minn.;

TP15: Pressure Sensitive Adhesive (PSA)-backed poly(methyl methacrylate) retro-reflective sheet, available as “1170” from 3M, St. Paul, Minn.;

TP16: Glass for photovoltaic solar cells, obtained from China South Glass Holding Co., Ltd, Shenzhen, China;

TP17: Ceramic tile, obtained from Dal-Tile Corporation, Dallas, Tex.;

TP18: High-performance styrene-acrylic roof coating material, SCOTCHKOTE POLY-TECH CSM 658 from 3M Company, St. Paul, Minn.

TP19: High-performance roof coating material, obtained as “SCOTCHKOTE POLY-TECH UV” from 3M Company, St. Paul, Minn.

### Silica Nanoparticles

NPS1: A 16.5 percent solids (nominally 15 percent solids) aqueous colloidal spherical silica dispersion (Mean Particle Diameter=4 nm), available as NALCO 1115 from NALCO Chemical Company;

NPS2: A 16.2 percent solids (nominally 15 percent solids) aqueous colloidal spherical silica dispersion (Mean Particle Diameter=5 nm), available as NALCO 2326 from NALCO Chemical Company of Naperville, Ill.;

NPS3: A 16.5 percent solids (nominally 15 percent solids) aqueous colloidal spherical silica dispersion (Mean Particle Diameter=13 nm), available as NALCO 1030 from NALCO Chemical Company;

NPS4: A 16.5 percent solids (nominally 15 percent solids) aqueous colloidal spherical silica dispersion (Mean Particle Diameter=20 nm), available as NALCO 2327 from NALCO Chemical Company;

NPS5: A 50 percent solids aqueous colloidal spherical silica dispersion (Mean Particle Diameter=20 nm), available as NALCO 1050 from NALCO Chemical Company;

NPS6: A 20 percent solids aqueous colloidal non-spherical silica dispersion, available as ST-UP from Nissan Chemical America Corporation of Houston, Tex.;

NPS7: A 20 percent solids aqueous colloidal non-spherical silica dispersion, available as ST-PS-S from Nissan Chemical America Corporation;

NPS8: A 20 percent solids aqueous colloidal non-spherical silica dispersion, available as ST-PS-M from Nissan Chemical America Corporation;

NPS9: 45 nm mean diameter nanosilica particles provided as a dispersion;

NPS10: 93 nm mean diameter nanosilica particles provided as a dispersion.

### Dispersed Polymeric Binders (Polyurethane Nanoparticle Dispersions)

FM1: An aqueous fluorinated polyurethane dispersion, obtained as “3M Stain Resistant Additive SRC-220” from 3M Company, St. Paul, Minn.;

PU1: A 33 percent solids aqueous aliphatic polyurethane emulsion, available as NEOREZ R-960 from DSM NeoResins, Inc., Wilmington, Mass.;

PU2: A 40 percent solids aqueous aliphatic polyurethane emulsion, available as NEOREZ R-967 from DSM NeoResins, Inc., Wilmington, Mass.;

PU3: A 40 percent solids aqueous aliphatic polyurethane emulsion, available as NEOREZ R-9036 from DSM NeoResins, Inc., Wilmington, Mass.;

PU4: A 40 percent solids aqueous aliphatic polyurethane emulsion, available as NEOREZ R-9699 from DSM NeoResins, Inc., Wilmington, Mass.;

PU5: A 35 percent solids aqueous anionic polyurethane dispersion, available as ESSENTIAL CC4520 from Essential Industries, Inc., Merton, Wis.;

PU6: A 32 percent solids aqueous anionic polyurethane dispersion, available as ESSENTIAL CC4560 from Essential Industries, Inc., Merton, Wis.;

PU7: A 33 percent solids aqueous anionic aliphatic polyester polyurethane dispersion, available as ESSENTIAL 84100 from Essential Industries, Inc., Merton, Wis.;

PU8: A 38 percent solids aqueous anionic aliphatic polyester polyurethane dispersion, available as ESSENTIAL R4188 from Essential Industries, Inc., Merton, Wis.;

PU9: A 32 percent solids aqueous aliphatic polyester polyurethane dispersion, available as SANCURE 843 from Lubrizol, Inc., Cleveland, Ohio;

PU10: A 32 percent solids aqueous aliphatic polyester polyurethane dispersion, available as SANCURE 898 from Lubrizol, Inc., Cleveland, Ohio;

PU11 A 40 percent solids aqueous aliphatic polyester polyurethane dispersion, available as SANCURE 12929 from Lubrizol, Inc., Cleveland, Ohio;

PU12: A 36 percent solids aqueous aliphatic self-crosslinking polyurethane dispersion, available as TURBOSET 2025 from Lubrizol, Inc., Cleveland, Ohio;

PU13: A 40 percent solids aqueous anionic, co-solvent free, aliphatic self-crosslinking polyurethane dispersion, available as BAYHYDROL PR240 from Bayer Material Science, LLC, Pittsburgh, Pa.;

PU14: A 35 percent solids aqueous aliphatic polyurethane emulsion, available as NEOREZ R-2180 from DSM NeoResins, Inc., Wilmington, Mass.;

PA1: A 42 percent solids aqueous aliphatic acrylic acid emulsion, available as NEOCRYL A-633 from DSM NeoResins, Inc., Wilmington, Mass.;

PA2: A 44 percent solids aqueous aliphatic acrylic acid emulsion, available as NEOCRYL A-655 from DSM NeoResins, Inc., Wilmington, Mass.;

PA3: A 45 percent solids aqueous aliphatic acrylic acid emulsion, available as NEOCRYL XK-90 from DSM NeoResins, Inc., Wilmington, Mass.;

PA4: An aqueous aliphatic acrylic acid emulsion, available as NEOCRYL A-612 from DSM NeoResins, Inc., Wilmington, Mass.

PS1: A 10.1 percent solids aqueous polystyrene emulsion.

### Acids

HCl: Hydrochloric acid, 36.5-38.0 percent unless otherwise noted;

OA: Oxalic acid.

### Coating Composition Additives

Tetraethoxysilane (TEOS, 99.9%) was obtained from Alfa Aesar, Ward Hill, Mass.

### Test Methods:

### Durability Test

The mechanical durability was evaluated by forcibly wiping the coated surface with dry and a wet Kimwipe™ tissue as indicated in the Examples. The number reported in the Tables refers to the number of wipes required to visibly remove the coating. Light transmission was used to determine if the coating was retained or removed.

### Easy Cleaning Test

A drop of dirty diesel oil, vegetable oil or soap was applied on the coating surfaces for a period of time (2 min to overnight). Subsequently, the contaminated areas were subjected to water rinsing until the dirty oil or vegetable oil was completely removed. Time consumed was recorded when the applied flow rate was set at 750 mL/min. Typically, the water rinse time is within 1 minute. Then 4-5 cleaning cycles were repeated. The cleanability was evaluated by the cleaning speed (the time) and the residual oil on the surfaces. The mechanical durability for easy cleaning was evaluated by forcibly rubbing the coating surfaces with wet KIMWIPE tissue.

### Anti-Soiling Test

A piece of the dried, coated substrate (approximately 20 mm×25 mm) was placed in a plastic box containing organic carpet dirt and glass bends in a 1:20 ratio by weight, and shaken for one minute. After removing the sample and tapping to remove any loosely adhered dirt, the anti-soiling benefits of the coated surface was visually observed and photographed. The anti-soiling property of tested samples was quantified with the Total Solar Reflection (TSR) measurement. Weathering Test

The Weathering Test was run using a Q-UV Weather Tester (available from Q-Lab Corporation, Cleveland, Ohio. Test specimens were secured in the testing machine and exposed in continuous 6-hour cycles of 5 hours of uv irradiation followed by 1 hour of dark and wet conditions (water spray only) at a temperature of 80-85 degrees F. (27-29 degrees C.). Specimens were periodically removed from the testing machine, placed in a plastic box containing carpet soil and glass bends in a 1:20 ratio by weight, and shaken for one minute. After tapping the specimen to remove loose soil, the specimens were evaluated for Total Solar Reflection.

### Total Solar Reflection (TSR) Measurement

Total Solar Reflection measurement was done on a Solar Spectrum Reflectometer (Model SSR-ER, available from Devices and Services Company in Dallas, Tex.). This instrument uses a tungsten halogen lamp to illuminate samples. Reflectance measurements were then collected at an angle of 20 degrees from the incident light at the following four wavelengths in the solar spectrum, 380 nanometers, 500 nanometers, 650 nanometers, and 1220 nanometers. These four measurements were then combined using a weighted average to approximate the response for incident solar irradiation. An air mass of 1.5 was used. The instrument was calibrated using a black body cavity sample of known solar reflectance greater than zero.

### Sample Preparation:

Silica nanoparticle dispersions (of the sizes indicated in the Examples) were diluted to 5 wt % with deionized water and acidified with concentrated aqueous HCl to the indicated pH (generally 2-3). For some Examples, the acidified silica nanoparticle dispersions (5wt %) were mixed with TEOS or organic solvents in ratios described in the Tables.

The indicated substrates were coated using a blocked coater or a Meyer bar with a 1 mil gap and 5 wt % silica dispersions (total silica weight), providing a dry coating thickness in a range of 100-200 nm. The coated samples were heated to 80-100° C. for 5 min to 10 min to effect drying.

A. Examples Using Dispersed Nanosilica particles

In the following Comparative Example 1 and Examples 1-5, a corona-treated polyethylene terephthalate (PET) substrate was coated with the indicated 5 wt. % nanoparticle silica compositions at a pH of 2-3 and at a coating thickness of 1 mil (˜25 micrometers) and dried at 80-100° C. for 5-10 minutes. The coated Examples were tested for mechanical durability and transmittivity increase using the previously described test methods. The results are shown in Table 1. For comparative purposes, a sample using 93 nm silica was also tested. From the test results in was concluded that the smaller particle sizes show improved durability.

TABLE 1

| | SiO₂ Nanoparticle | Mechanical Durability |
|---|---|---|
| Example | Dispersion | (# wipes - dry/wet) |
| Comparative Ex. 1 | NPS10 (93 nm) | 1/1 |
| 1 | NPS9 (45 nm) | 1/1 |
| 2 | NPS4 (20 nm) | 2/2 |
| 3 | NPS2 (5 nm) | 11/>30 |
| 4 | Mixed NPS9/NPS4 | 1/1 |
| | (45 nm/20 nm) | |
| | in 1:1 ratio | |
| 5 | Mixed NPS9/NPS2 | 6/>15 |
| | (45 nm/5 nm) | |
| | in 1:1 ratio | |

In the following Examples 6-8, an untreated polyethylene terephthalate substrate was coated and tested for Mechanical Durability as previously described. The results are provided in Table 3. The aqueous acidified dispersions of 45 nm or greater particle sizes alone were not readily coatable on this substrate.

TABLE 2

| | SiO₂ Nanoparticle | Mechanical Durability |
|---|---|---|
| Example | Dispersion | (# wipes - dry/wet) |
| 6 | NPS2 | 6/>20 |
| | (5 nm) | |
| 7 | Mixed NPS9/NPS4 | 1/1 |
| | (45 nm/20 nm) | |
| | in 1:1 ratio | |
| 8 | Mixed NPS9/NPS2 | 4/>10 |
| | (45 nm/5 nm) | |
| | in 1:1 ratio | |

In the following Examples 9-20, a corona-treated polyethylene terephthalate substrate was coated with the indicated 5 wt. % nanoparticle silica compositions at a pH of 2-3 and at a coating thickness of 1 mil (˜=25 micrometers) and dried at 110-120° C. for 5-10 minutes. Some Examples further contained tetraethoxysilane (TEOS) in the indicated proportion. The coated Examples were tested as previously described. From the test results (Table 3) it is concluded that the addition of tetraethoxysilane improves the durability of the coatings.

TABLE 3

| | | Mechanical Durability |
|---|---|---|
| Example | SiO₂ Nanoparticle Dispersion | (# wipes - dry/wet) |
| 9 | 100% NPS9 (45 nm) | 1/1 |
| 10 | 90% NPS9 (45 nm) | 4/4 |
| | 10% TEOS | |
| 11 | 70% NPS9 (45 nm) | 7/200 |
| | 30% TEOS | |
| 12 | 50% NPS9 (45 nm) | 12/200 |
| | 50% TEOS | |
| 13 | 100% NPS4 (20 nm) | 2/2 |
| 14 | 90% NPS4 (20 nm) | 6/200 |
| | 10% TEOS | |
| 15 | 70% NPS4 (20 nm) | 10/200 |
| | 30% TEOS | |
| 16 | 50% NPS4 (20 nm) | 15/200 |
| | 50% TEOS | |
| 17 | 100% NPS2 (5 nm) | 5/30 |
| 18 | 90% NPS2 (5 nm) | 8/200 |
| | 10% TEOS | |
| 19 | 70% NPS2 (5 nm) | 12/200 |
| | 30% TEOS | |
| 20 | 50% NPS2 (5 nm) | 18/200 |
| | 50% TEOS | |

In the following Examples 21-28, a corona-treated polyethylene terephthalate substrate was coated with the indicated 5 wt. % mixed nanoparticle silica compositions (containing a mixture of different sizes) at a pH of 2-3 and at a coating thickness of 1 mil (˜25 micrometers) and dried at 110-120° C. for 5-10 minutes. Some Examples further contained tetraethoxysilanes (TEOS) in the indicated proportion. The coated Examples were tested as previously described. From the test results reported in Table 4, it is concluded that TEOS improves the durability in mixed-particle systems.

TABLE 4

| | | Mechanical Durability |
|---|---|---|
| Example | SiO₂ Nanoparticle Dispersion | (# wipes - dry/wet) |
| 21 | 50% NPS9 (45 nm) | 1/1 |
| | 50% NPS4 (20 nm) | |
| 22 | 45% NPS4 (20 nm) | 6/60 |
| | 45% NPS9 (45 nm) | |
| | 10% TEOS | |
| 23 | 35% NPS4 (20 nm) | 12/200 |
| | 35% NPS9 (45 nm) | |
| | 30% TEOS | |
| 24 | 25% NPS4 (20 nm) | 15/200 |
| | 25% NPS9 (45 nm) | |
| | 50% TEOS | |
| 25 | 50% NPS9 (45 nm) | 5/15 |
| | 50% NPS2 (5 nm) | |
| 26 | 45% NPS2 (5 nm) | 6/200 |
| | 45% NPS9 (45 nm) | |
| | 10% TEOS | |
| 27 | 35% NPS2 (5 nm) | 9/200 |
| | 35% NPS9 (45 nm) | |
| | 30% TEOS | |
| 28 | 25% NPS2 (5 nm) | 13/200 |
| | 25% NPS9 (45 nm) | |
| | 50% TEOS | |

In the following Examples 29-32, an untreated polyethylene terephthalate substrate was coated with the indicated 5 wt. % nanoparticle silica compositions at a pH of 2-3 and at a coating thickness of 1 mil (˜25 micrometers) and dried at 110-120° C. for 5-10 minutes. The composition further contained tetraethoxysilanes (TEOS) in the indicated proportion. The coated Examples were tested as previously described. From the test results reported in Table 5, it is concluded that tetralkoxysilane improves coating durability on untreated PET.

TABLE 5

| | | Mechanical Durability |
|---|---|---|
| Example | SiO₂ Nanoparticle Dispersion | (# wipes - dry/wet) |
| 29 | 100% NPS2 (5 nm) | 6/>30 |
| 30 | 90% NPS2 (5 nm) | 7/200 |
| | 10% TEOS | |
| 31 | 70% NPS2 (5 nm) | 10/200 |
| | 30% TEOS | |
| 32 | 50% NPS2 (5 nm) | 18/200 |
| | 50% TEOS | |

In the following Examples 33-40, an untreated polyethylene terephthalate substrate was coated with the indicated 5 wt. % mixed nanoparticle silica compositions (containing a mixture of different sizes) at the indicated pH and at a coating thickness of 1 mil (˜25 micrometers) and dried at 80-100° C. for 5-10 minutes. The composition further contained tetraethoxysilanes (TEOS) in the indicated proportion. The coated Examples were tested as previously described. From the test results reported in Table 6, it is concluded that tetralkoxysilane improves coating durability of mixed particle compositions on untreated PET.

TABLE 6

| | | Mechanical Durability |
|---|---|---|
| | | [Coating peeled off after x |
| | | time strong rubs with a dry |
| | SiO₂ Nanoparticle | Kimwipe, and y time strong |
| Example | Dispersion | rubs with wet Kimwipe (x/y)] |
| 33 | 50% NPS9 (45 nm) | 1/1 |
| | 50% NPS4 (20 nm) | |
| 34 | 45% NPS4 (20 nm) | 4/12 |
| | 45% NPS9 (45 nm) | |
| | 10% TEOS | |
| 35 | 35% NPS4 (20 nm) | 8/200 |
| | 35% NPS9 (45 nm) | |
| | 30% TEOS | |
| 36 | 25% NPS4 (20 nm) | 12/200 |
| | 25% NPS9 (45 nm) | |
| | 50% TEOS | |
| 37 | 50% NPS9 (45 nm) | 2/4 |
| | 50% NPS2 (5 nm) | |
| 38 | 45% NPS2 (5 nm) | 4/150 |
| | 45% NPS9 (45 nm) | |
| | 10% TEOS | |
| 39 | 35% NPS2 (5 nm) | 7/200 |
| | 35% NPS9 (45 nm) | |
| | 30% TEOS | |
| 40 | 25% NPS2 (5 nm) | 10/200 |
| | 25% NPS9 (45 nm) | |
| | 50% TEOS | |

In the following Examples 41-42, an untreated polyethylene terephthalate substrate was coated with the indicated 5 wt. % mixed nanoparticle silica compositions at a pH of 2-3 and at a coating thickness of 1 mil (˜25 micrometers) and dried at 80-100° C. for 5-10 minutes. The Examples compare the performance from an aqueous dispersion vs. an ethanolic dispersion. The Mechanical Durability was tested with a wet Kimwipe® only. The comparative example illustrates the poor performance when the ethanol is not acidified. The results are summarized in Table 7.

TABLE 7

| | SiO₂ Nanoparticle | Wet Mechanical |
|---|---|---|
| Example | Dispersion | Durability |
| 41 | NPS2 (5 nm) | 20 |
| | (5 wt % aqueous dispersion) | |
| 42 | NPS2 (5 nm) | 5 |
| | (5 wt % in 71% ethanol) | |
| Comparative Ex. 2 | NPS2 (5 nm) | 2 |
| | (5 wt % in 71% ethanol) | |

In the following Examples and Comparative Examples, the pH dependence of the coating performance was examined. In the Comparative Examples, the nanoparticles were coated as basic dispersions. The coating performance was then compared to dispersions where the pH was adjusted to 2-3, and then compared to dispersion where the pH of the acidic dispersions was again adjusted to pH 5-6 prior to coating. Each dispersion had 5 wt % nanoparticles as indicated in Table 8. The substrate was untreated PET. Dispersions that provided a visually uniform coating are designated “coatable”. Coatings that beaded up and/or provided a visually non-uniform coating were designated “beading”. Examples of nanoparticle emulsions having mixed sizes are also provided. These Examples demonstrate the effect of acidification on coatability and retained coatability upon readjustment of pH.

TABLE 8

| | SiO₂ | | | | Coating |
|---|---|---|---|---|---|
| | Nanoparticle | Initial | Acidified | Readjusted | perfor- |
| Example | Dispersion | pH | pH | pH | mance |
| Comparative | NPS1 (4 nm) | 10 | n/a¹ | n/a | beading |
| Ex. 3 | | | | | |
| 43 | NPS1 (4 nm) | 10 | 1-3 | n/a | coatable |
| 44 | NPS1 (4 nm) | 10 | 1-3 | 5-6 | coatable |
| Comparative | NPS2 (5 nm) | 10 | n/a | n/a | beading |
| Ex. 4 | | | | | |
| 45 | NPS2 (5 nm) | 10 | 1-3 | n/a | coatable |
| 46 | NPS2 (5 nm) | 10 | 1-3 | 5-6 | coatable |
| Comparative | NPS4 (20 nm) | 10 | n/a | n/a | beading |
| Ex. 5 | | | | | |
| 47 | NPS4 (20 nm) | 10 | 1-3 | n/a | coatable |
| 48 | NPS4 (20 nm) | 10 | 1-3 | 5-6 | coatable |
| Comparative | NPS9 (45 nm) | 10 | n/a | n/a | beading |
| Ex. 6 | | | | | |
| 49 | NPS9 (45 nm) | 10 | 1-3 | n/a | beading |
| 50 | NPS1 (4 nm)/ | 10 | 1-3 | n/a | coatable |
| | NPS9 (45 nm) | | | | |
| | in 1/1 | | | | |
| 51 | NPS1 (4 nm)/ | 10 | 1-3 | n/a | coatable |
| | NPS9 (45 nm) | | | | |
| | in 1/9 | | | | |
| 52 | NPS2 (5 nm)/ | 10 | 1-3 | n/a | coatable |
| | NPS9 (45 nm) | | | | |
| | in 1/1 | | | | |
| 53 | NPS2 (5 nm)/ | 10 | 1-3 | n/a | coatable |
| | NPS9 (45 nm) | | | | |
| | in 1/9 | | | | |
| 54 | NPS1 (4 nm)/ | 10 | 1-3 | n/a | coatable |
| | NPS10 (93 nm) | | | | |
| | in 1/1 | | | | |
| 55 | NPS1 (4 nm)/ | 10 | 1-3 | n/a | coatable |
| | NPS10 (93 nm) | | | | |
| | in 1/9 | | | | |
| 56 | NPS2 (5 nm)/ | 10 | 1-3 | n/a | coatable |
| | NPS10 (93 nm) | | | | |
| | in 1/1 | | | | |
| 57 | NPS2 (5 nm)/ | 10 | 1-3 | n/a | coatable |
| | NPS10 (93 nm) | | | | |
| | in 1/9 | | | | |

¹n/a = not applicable

In Examples 58-63 and Comparative Examples 7-8 an untreated polyethylene terephthalate substrate was coated with the indicated 5 wt. % nanoparticle silica compositions at the indicated pH, at a coating thickness of 1 mil (˜25 micrometers) and dried at 110-120° C. for 5-10 minutes. Example 59, 60, 62 and 63 contained the surfactant SIPONATE™ DS-10 from Rhone-Poulenc, Inc. in a 98:2 silica to surfactant ratio. The static water contact angle was measured and is reported in Table 9 (below). These examples demonstrate the effect of pH on coatability and on coating performance.

TABLE 9

| | | | | Water |
|---|---|---|---|---|
| | SiO₂ Nanoparticle | | Coating | Contact |
| Example | Dispersion | pH | Quality | Angle |
| Comparative | NPS1 (4 nm) | 10 | Very poor many | 18.4 |
| Ex. 7 | (70/30 water/alcohol) | | defects and | |
| | | | pinholes | |
| 58 | NPS1 (4 nm) | 2-3 | Very good | 10.0 |
| | (aqueous) | | | |
| 59 | NPS1 (4 nm) | 2-3 | Very good | 5.2 |
| | (98/2 water/DS-10) | | | |
| 60 | NPS1 (4 nm) | 2-3 | Very good | 5.4 |
| | (95/5 water/DS-10) | | | |
| Comparative | NPS2 (5 nm) | 10 | Very poor, | 14.5 |
| Ex. 8 | (30/70 water/alcohol) | | many defects, | |
| | | | many pinholes | |
| 61 | NPS2 (5 nm) | 2-3 | Very good | 9.2 |
| | (aqueous) | | | |
| 62 | NPS2 (5 nm) | 2-3 | Very good | 5.3 |
| | (98/2 water/DS-10) | | | |
| 63 | NPS2 (5 nm) | 2-3 | Very good | 4.6 |
| | (95/5 water/DS-10) | | | |

In the following Examples 64-82 and Comparative Examples 9-14 an untreated polyethylene terephthalate substrate was coated with the indicated 5 wt. % nanoparticle silica compositions at the indicated pH, at a coating thickness of 1 mil (˜25 micrometers) and dried at 110-120° C. for 5-10 minutes. The water advancing and receding contact angles are reported. In Example 84, the substrate was a polycarbonate having a perfluoropolyether coating, prepared according to Example 1 of U.S. Pat. App. Pub. No. 2009-0025727 (Klun et al.), using as the top coating a solution of SHC-1200 containing 0.5 wt. % of Preparation 2. In Example 85, the substrate was an anhydride modified polyethylene (co)polymer sold under the tradename Bynel™ and commercially available from E. I. DuPont de Nemours & Co., Wilmington, Del. Stable means no gelation in at least 2 months. As summarized in Table 10, these examples demonstrate that dispersion stability and coatability is related to pH and to particle size.

TABLE 10

| | SiO₂ | | | Contact | Shelf Life | |
|---|---|---|---|---|---|---|
| | Nanoparticle | | | Angle | of | |
| Example | Dispersion | Substrate | pH | (Adv/Rec °) | Dispersion | Coatability |
| Comparative | Deionized | PET | 7 | 74.0/63.0 | n/a | beading |
| Ex. 9 | water only | | | | | |
| Comparative | NPS2 (5 nm) | ″ | 10.5 | 72.1/61.5 | stable | coatable |
| Ex. 10 | | | | | | |
| 64 | NPS2 (5 nm) | ″ | 2 | 72.5/21.9 | stable | coatable |
| 65 | NPS2 (5 nm) | ″ | 3 | 70.7/23.7 | Gelled after | coatable |
| | | | | | 7 days | |
| 66 | NPS2 (5 nm) | ″ | 4 | 71.9/20.0 | Gelled after | coatable |
| | | | | | 5 days | |
| 67 | NPS2 (5 nm) | ″ | 5 | 72.1/19.0 | Gelled after | coatable |
| | | | | | 6 days | |
| Comparative | NPS1 (4 nm) | ″ | 9.5 | 72.2/55.5 | Stable | beading |
| 11 | | | | | | |
| 68 | NPS1 (4 nm) | ″ | 2 | 75.0/21.5 | Stable | coatable |
| 69 | NPS1 (4 nm) | ″ | 3 | | Gelled after | coatable |
| | | | | | 24 hrs | |
| 70 | NPS1 (4 nm) | ″ | 4 | 75.1/27.6 | Gelled after | coatable |
| | | | | | 2 days | |
| 71 | NPS1 (4 nm) | ″ | 5 | 74.2/22.6 | Gelled after | coatable |
| | | | | | 24 hrs | |
| 72 | NPS3 (13 nm) | ″ | 2 | 80.4/21.2 | Stable | coatable |
| 73 | NPS3 (13 nm) | ″ | 3 | 79.8/22.1 | Stable | coatable |
| 74 | NPS3 (13 nm) | ″ | 4 | 80.9/40.1 | Stable | beading |
| 75 | NPS3 (13 nm) | ″ | 5 | 81.1/55.7 | Stable | beading |
| 76 | NPS3 (13 nm) | ″ | 6 | 79.8/57.3 | Stable | beading |
| Comparative | NPS4 (20 nm) | ″ | 9.5 | 77.9/54.4 | Stable | beading |
| Ex. 12 | | | | | | |
| 78 | NPS4 (20 nm) | ″ | 2 | 79.6/19.4 | Stable | coatable |
| 79 | NPS4 (20 nm) | ″ | 3 | | Stable | coatable |
| 80 | NPS4 (20 nm) | ″ | 4 | 80.5/25.5 | Stable | coatable |
| Comparative | NPS4 (20 nm) | ″ | 5 | 79.2/44.6 | Stable | beading |
| Ex. 13 | | | | | | |
| Comparative | NPS4 (20 nm) | ″ | 6 | 79.9/55.9 | Stable | beading |
| Ex. 14 | | | | | | |
| 81 | NPS2 (5 nm) | Polycarbonate | 2 | 88:1/31.1 | Stable | coatable |
| 82 | NPS2 (5 nm) | Polyurethane | 2 | 104.8/24.2 | stable | coatable |
| 83 | NPS2 (5 nm) | PVC | 2 | 70.2/23.2 | stable | coatable |
| 84 | NPS2 (5 nm) | PFPE on | 2 | 109.2/24.3 | Stable | coatable |
| | | PC | | | | |
| 85 | NPS2 (5 nm) | Bynel | 2 | 80.2/30.3 | Stable | coatable |

In the following Example 94 and Comparative Example 17 an untreated polyethylene terephthalate substrate was coated with the indicated 5 wt. % nanoparticle silica compositions at the indicated pH, at a coating thickness of 1 mil (˜25 micrometers) and dried at 110-120° C. for 5-10 minutes. Rinse away cleaning for easy removal of oil was carried out by applying a few drops of oil onto the coated Examples and subsequently successfully rinsing off the oil with a narrow stream of water at a speed of 750mL/min. The results are summarized in Table 11.

TABLE 11

| | Type of SiO₂ | | Easy | Easy Removal |
|---|---|---|---|---|
| | Nanoparticle | | Removal of | of Dirty Diesel |
| Example | Dispersion | pH | Food Oil | Oil |
| 94 | NPS2 (5 nm) | 2-3 | Complete Oil | Complete Oil |
| | | | Removal | Removal |
| Comparative | None | n/a | Oil | Oil |
| Ex. 17 | | | Remained | Remained |

B. Examples Using Core/Shell Nanosilica Dispersions

In Example 95, NPS3 (1.992 grams (g)) was manuall_{y} mixed with 4.404 g of deionized water. A master batch of 4.5 percent solids polyurethane dispersion was prepared by manually mixing until homogeneous, 5.125 g of PU1 with 32.113 g of deionized water at 22° C. A dispersion having a silica:polyurethane ratio of 9:1 was made by manually mixing at 22° C. until homogeneous, the diluted NPS with 0.787 g of the 4.5 percent solids PU1. To this was added 2 drops HCl, and the mixture was agitated. The dispersion was then diluted to a total solids content of 0.5 wt. % with deionized water, and the pH was measured using pH paper.

A process analogous to that described in Example 95 was used to prepare Examples 96-105. A master batch of 5.32 percent solids NPS3 was prepared by manually mixing until homogeneous 30.013 g of NPS3 with 66.014 g of deionized water at 22° C. Aliquots (approximately 6.4 g each) of the 5.32 percent solids NPS3 master batch were combined with suitable amounts of 4.5 percent solids polyurethane dispersions PU2 and PU5-PU13. As indicated in Table 1, drops of HCl were added to these mixtures after which each NPS:PU dispersion was then diluted to a total solids content of between 0.50-1.00 percent and silica:polyurethane ratios of between 9:1 to 7:3. Compositions of Examples 95-105 are reported in Table 12.

TABLE 12

| | Polyurethane | Silica/Urethane | DROPS | Total Solids, | |
|---|---|---|---|---|---|
| Example | Dispersion | Ratio | HCl | Percent | pH |
| 95 | PU1 | 9:1 | 2 | 0.50 | 2.5 |
| 96 | PU2 | 8:2 | 1 | 0.75 | 4.0 |
| 97 | PU5 | 9:1 | 0 | 0.50 | 8.5 |
| 98 | PU6 | 7:3 | 0 | 0.50 | 8.5 |
| 99 | PU7 | 7:3 | 2 | 0.50 | 3.0 |
| 100 | PU8 | 8:2 | 1 | 0.75 | 4.0 |
| 101 | PU9 | 8:2 | 1 | 0.75 | 4.0 |
| 102 | PU10 | 7:3 | 0 | 1.00 | 9.5 |
| 103 | PU11 | 9:1 | 2 | 1.00 | 2.0 |
| 104 | PU12 | 9:1 | 0 | 1.00 | 9.0 |
| 105 | PU13 | 7:3 | 2 | 1.00 | 2.5 |

One-inch by two-inch (2.54 by 5.08 centimeters (cm)) aluminum coupons of test panels TP1, TP2 and TP3 were sprayed with ethanol and wiped dry prior to applying the test dispersions. In the coating process, a single drop of each test dispersion was placed on a test panel and then wiped down the long axis of the panel using several strokes with a large rectangular foam pad swab, type CRITICAL SWAB, Catalog No. 89022-984 from VWR Scientific of West Chester, Pa. The coupons were laid flat and dried at 22° C. for 24 hours. Static water contact angles (SWCA) were then measured on each of three separate drops evenly spaced along the long axis of each coupon. The coupons were then subjected to two wet sponge abrasion cycles using a BYK-Gardner Abrasion Tester, obtained from BYK-Gardner Company of Columbia, Md. The SWCA was again measured, after which the coupons were subjected to another 8 abrasion cycles and the SWCA was again measured. Results, presented as an average (AVG.) from all test coupons and with standard deviation (SD), are reported in Table 13.

TABLE 13

| | SWCA (Degrees) | | |
|---|---|---|---|
| | | After 2 | After 10 |
| | Initial | Abrasion Cycles | Abrasion Cycles |
| Example | (AVG./SD) | (AVG./SD) | (AVG./SD) |
| 95 | 6.8/8.6 | 15.9/7.5 | 23.5/8.5 |
| 96 | 64.5/11.8 | 57.5/15.9 | 59.3/4.6 |
| 97 | 63.5/8.2 | 62.6/7.1 | 54.8/9.5 |
| 98 | 71.6/2.2 | 64.3/7.0 | 54.9/11.9 |
| 99 | 58.5/10.6 | 53.5/13.4 | 51.9/6.8 |
| 100 | 30.4/24.1 | 41.2/16.7 | 40.9/13.8 |
| 101 | 30.3/22.5 | 42.9/22.1 | 42.1/13.5 |
| 102 | 69.7/2.6 | 60.5/10.9 | 57.5/5.8 |
| 103 | 3.4/4.9 | 14.6/5.4 | 21.1/6.1 |
| 104 | 63.6/6.3 | 66.3/3.2 | 63.5/7.3 |
| 105 | 48.0/4.3 | 50.9/7.8 | 56.3/9.7 |

A master batch of 5.33 percent solids of NPS3 dispersion was prepared by manually mixing until homogeneous 31.049 g of NPS3 with 63.389 g of deionized water at 22° C. Dispersions of polyurethanes PU2 and PU5-PU11 containing 5 percent solids were made by diluting the as-received dispersions with the appropriate amount of deionized water. Approximately 0.65 g of the diluted polyurethanes were then mixed with approximately 6.3 g of the 5.33 percent solids NPS3 master batch to provide a mixture having a total solids content of 5.25 percent solids. One drop of HCl was added to each of these nanoparticle silica-polyurethane dispersions and the pH recorded using pH paper. Contact angles of these examples were measured on one-inch by two-inch (2.54 cm by 5.08 cm) TP2 test panels which had been coated by wiping down two applied drops of each coating using KIM-WIPE EX-L wipes. The dispersions were diluted to 2.5 percent solids and additional test panels were coated. Contact angles were again measured. Results are reported in Table 14.

TABLE 14

| | | 5.3 Percent | | 2.5 Percent | |
|---|---|---|---|---|---|
| | | Total Solids | | Total Solids | |
| | PU | | Static Water | | Static Water |
| Example | Dispersion | pH | Contact Angle | pH | Contact Angle |
| 106 | PU2 | 1.5-2 | 39.3 | 2 | 47.3 |
| 107 | PU5 | 2.5 | 17.3 | 4 | 16.8 |
| 108 | PU6 | 2 | 7.9 | 2.5 | 12.5 |
| 109 | PU7 | 2 | 5.7 | 2 | 10.9 |
| 110 | PU8 | 2 | 21.5 | 5.5 | 26.9 |
| 111 | PU9 | 2 | 6.9 | 2.5 | 15.7 |
| 112 | PU10 | 2 | 4.1 | 2 | 8.6 |
| 113 | PU11 | 1.5-2 | 19.3 | 2 | 26.2 |
| 114 | PU12 | 2 | 3.9 | 2 | 0 |
| 115 | PU13 | 2 | 19.1 | 2.5 | 20.8 |

The optimal average dry coating thickness is dependent upon the particular composition that is coated, but in general the average thickness of the dried coating composition is between 0.05 to 5 micrometers, preferably 0.05 to 1 micrometer; for example, as estimated from atomic force microscopy and/or surface profilometry. Above this range, the dry coating thickness variations typically cause optical interference effects, leading to visible iridescence (rainbow effect) of the dried coating which is particularly apparent on darker substrates. Below this range the dry coating thickness may be inadequate to confer sufficient durability for most coatings exposed to environmental wear.

C. Coating Compositions Applied to Reflective Substrates

SCOTCHKOTE POLY-TECH UV coating (a urethane roof coating available from 3M Company, St., Paul, Minn.) was added to a rectangular TEFLON well having dimensions of 2 mm×610 mm×300 mm, in an amount sufficient to cover the well. The surface was smoothed with a TEFLON bar by moving the bar from one end to the other while pressing the bar against the opposite side edges of well. The wet film was allowed to cure in a fume hood for three days. A white elastomeric substrate was obtained by removing the cured film from the TEFLON well.

A separate 150 mm×250 mm of this TP14 substrate was used in each of the following examples. Half of each substrate (˜75 mm×250 mm) was coated using a #10 Mayer bar with a silica-containing nanoparticle dispersion as described below in Examples 116-121. After coating, each substrate was allowed to air dry for about three minutes. Each substrate was then placed in an oven maintained at about 120° C. for about 10 minutes. After removal from the oven, each sample was cooled to room temperature, and subjected to the Anti-soiling Test.

### Example 116

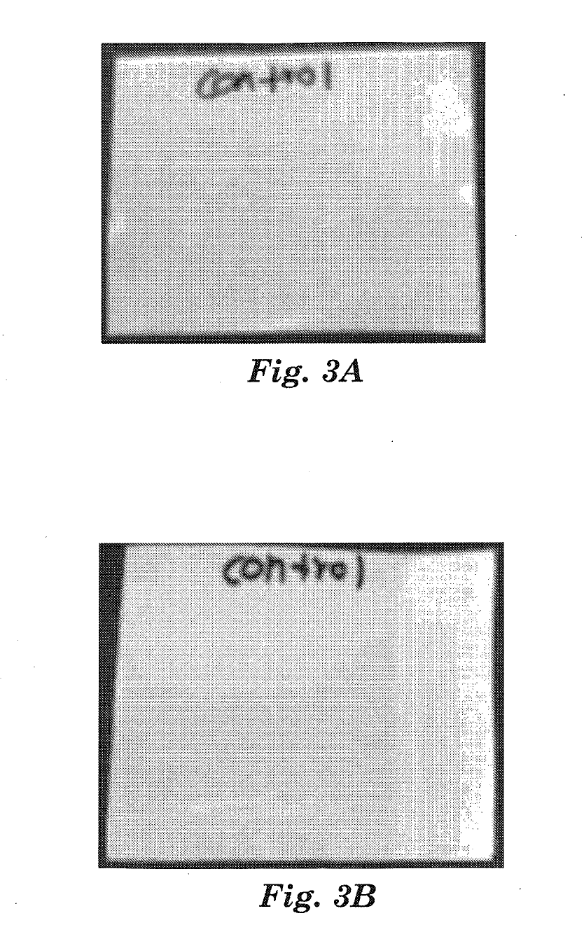

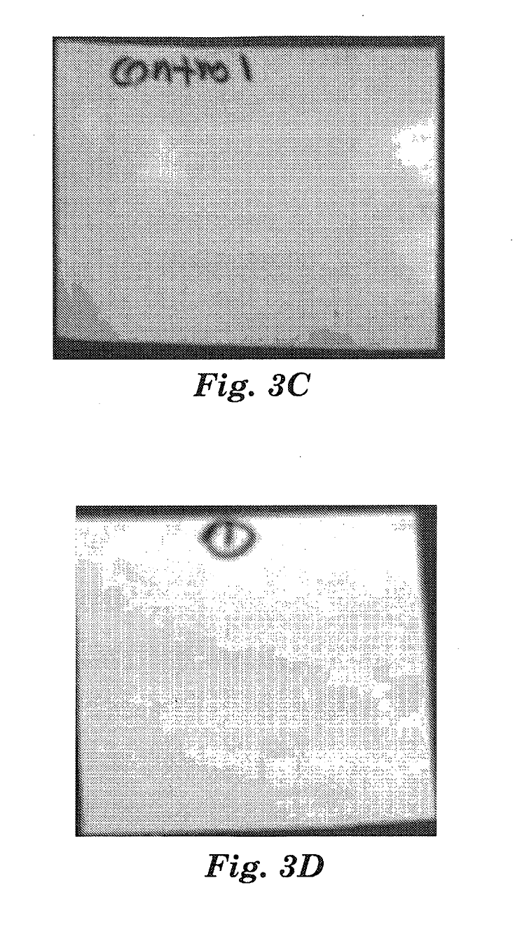

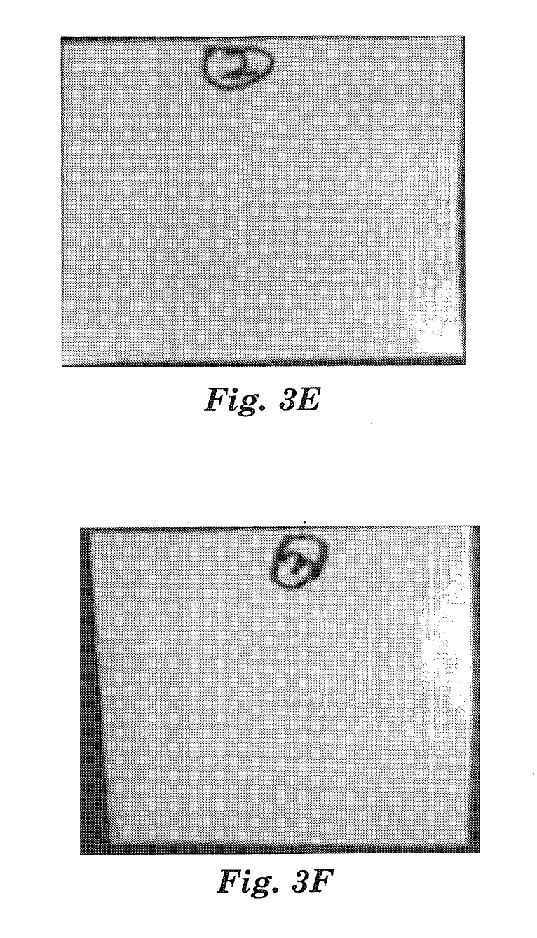

The coating composition was an aqueous dispersion formed by combining NPS1 (4 nm) and NPS5 (20 nm) silica nanoparticle dispersions at a weight ratio of 70 to 30, and a solids content of 10 wt. %, and acidifying with HCl. The anti-soiling benefits of the dried nanosilica-containing coating composition on the substrate after being subjected to the Anti-soiling Test is shown by the photographs in FIGS. 3A (uncoated control half) and 3D (coated half).

### Example 117

This Example was prepared and tested following the same procedures as described for Example No. 116, except that the nanosilica-containing coating composition used in this Example was an aqueous dispersion of a core-shell structured formed by combining NPS5 (20 nm) silica nanoparticle dispersion (shell) and a (40 nm) polyurethane dispersion (Neoree R960, obtained from DSM Corp.) (core) at a weight ratio (shelUcore) of 70/30, and a solids content of 10 wt. %, and acidifying with HCl. The anti-soiling benefits of the dried nanosilica-containing coating composition on the substrate after being subjected to the Anti-soiling Test is shown by the photographs in FIGS. 3B (uncoated control half) and 3E (coated half).

### Example 118

This Example was prepared and tested following the same procedures as described for Example No. 116, except that the nanosilica-containing coating composition used in this Example was an aqueous dispersion of a core-shell structured formed by combining NPS5 (20 nm) silica nanoparticle dispersion (shell) and a (40 nm) polyurethane dispersion (Neoree R960, obtained from DSM Corp.) (core) at a weight ratio (shell/core) 90/10 and a solids content of 10 wt. %, and acidifying with HCl. The anti-soiling benefits of the dried nanosilica-containing coating composition on the substrate after being subjected to the Anti-soiling Test is shown by the photographs in FIGS. 3C (uncoated control half) and 3F (coated half).

### Example 119

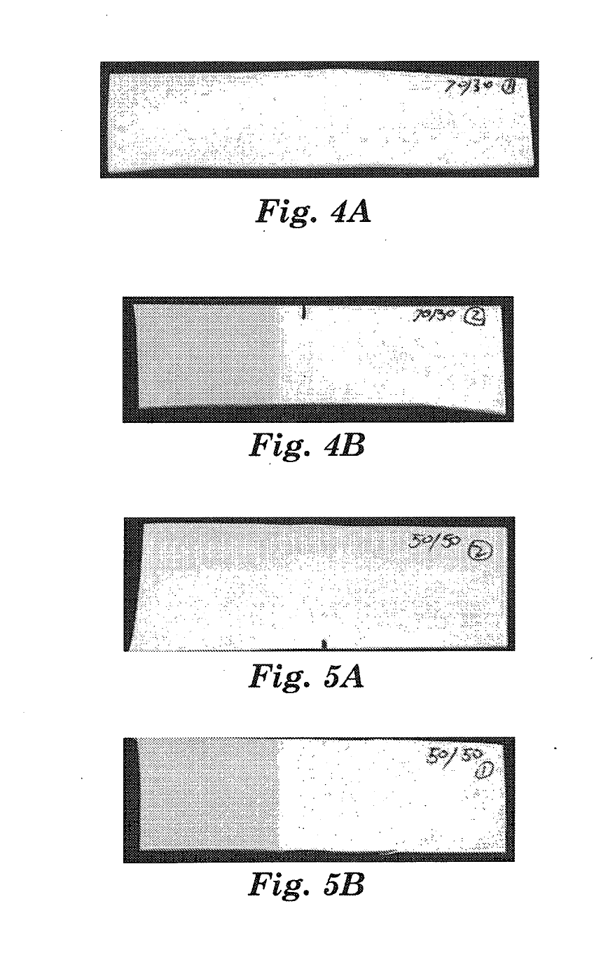

This Example was prepared and tested following the same procedures as described for Example No. 116, except that the nanosilica-containing coating composition used in this Example was an aqueous dispersion formed by combining NPS1 (4 nm) and NPS5 (20 nm) silica nanoparticle dispersions at a weight ratio of 70 to 30, and a solids content of 10 wt. %, and acidifying with HCl. The anti-soiling benefits of the dried nanosilica-containing coating composition on the substrate after being subjected to the Anti-soiling Test is shown by the photographs in FIGS. 4A (coated) and 4B (uncoated).

### Example No. 120

This Example was prepared and tested following the same procedures as described for Example No. 116, except that the nanosilica-containing coating composition used in this Example was an aqueous dispersion formed by combining NPS1 (4 nm) and NPS5 (20 nm) silica nanoparticle dispersions at a weight ratio of 50 to 50, and a solids content of 10 wt. %, and acidifying with HCl. The anti-soiling benefits of the dried nanosilica-containing coating composition on the substrate after being subjected to the Anti-soiling

Test is shown by the photographs in FIGS. 5A (coated) and 5B (coated).

### Example 121

This Example was prepared and tested following the same procedures as described for Example No. 116, except that the nanosilica-containing coating composition used in this Example was an aqueous dispersion formed by combining NPS1 (4 nm) and NPS5 (20 nm) silica nanoparticle dispersions at a weight ratio of 30 to 70, and a solids content of 10 wt. %, and acidifying with HCl. The coating composition was applied to the bottom half of a glass substrate, and to the bottom half of a poly(ethylene terephthalate) (PET) substrate. In addition, a coating composition including only NPS1, and another coating composition including only NPS5, were each applied separately to the bottom half of a separate glass substrate, and to the bottom half of a separate PET substrate.

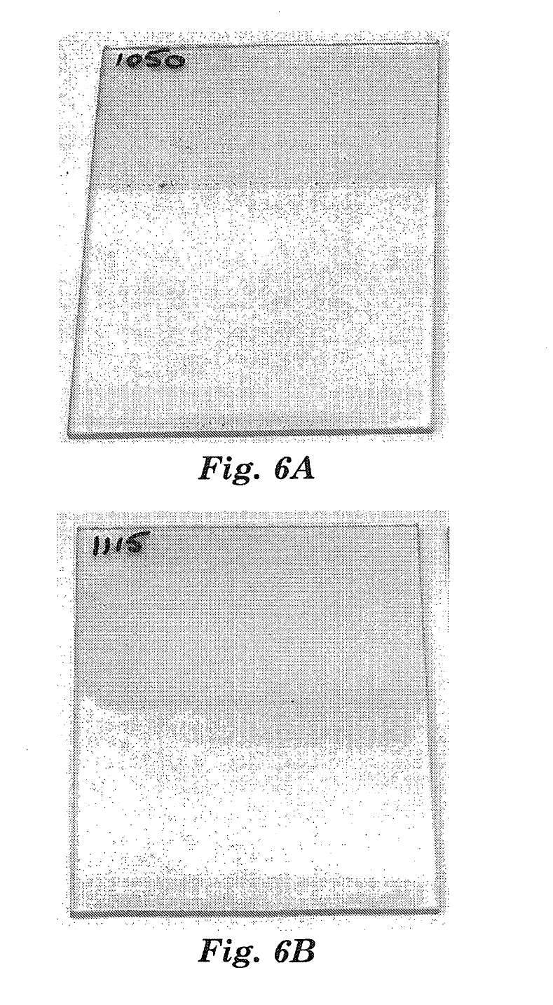

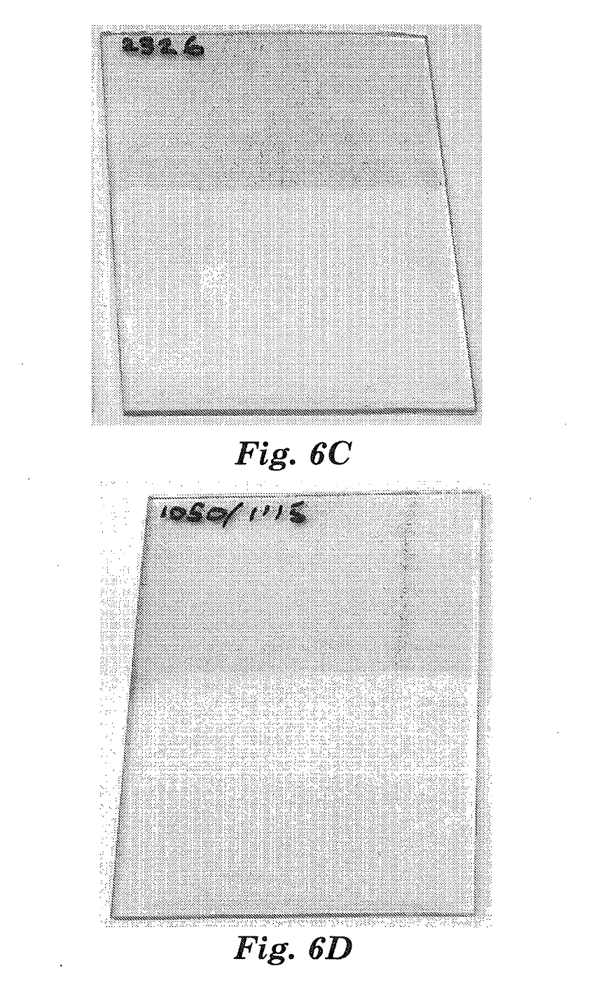

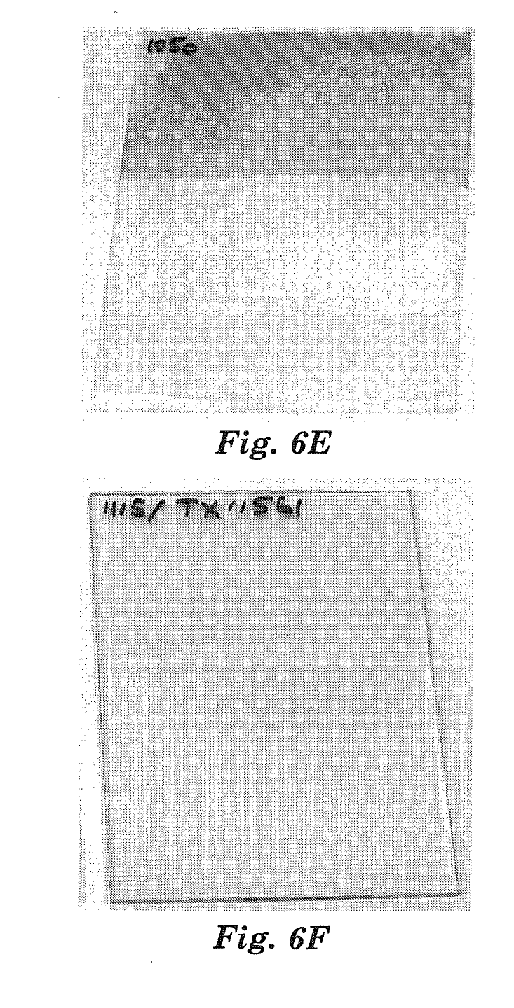

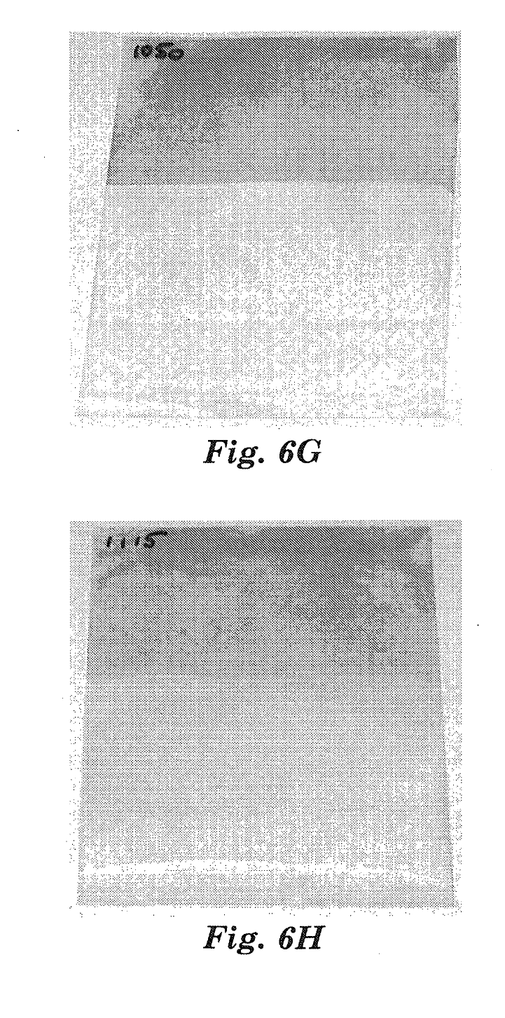

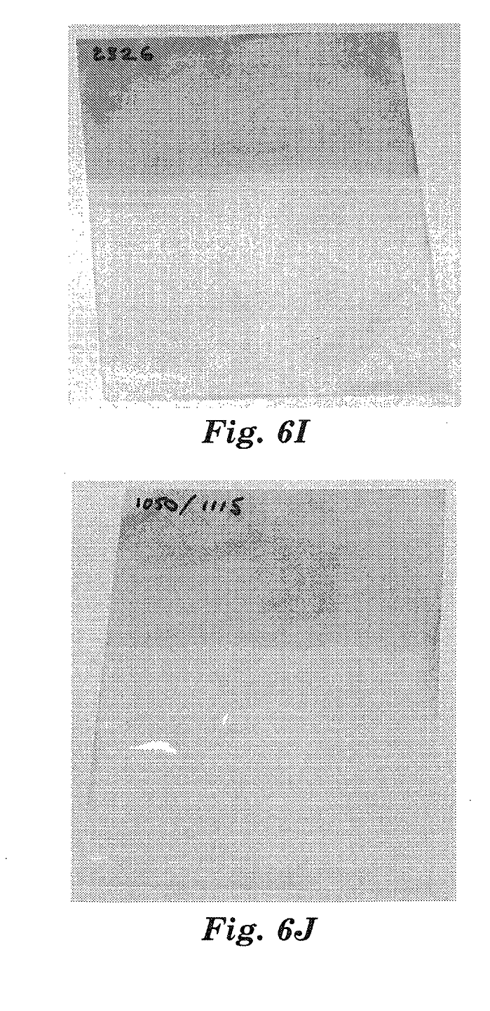

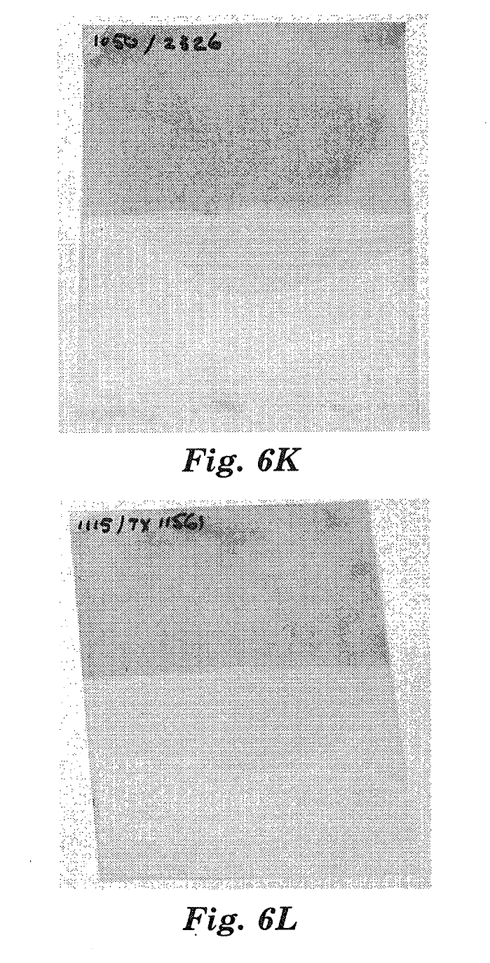

The anti-soiling benefits of the dried nanosilica-containing coating compositions applied to and dried on a glass substrate after being subjected to the Anti-soiling Test is shown by the photographs in FIGS. 6A (NPS5 alone), 6B (NPS1 alone) and 6D (the coating combination of NPS1 and NPS5 as described above). The anti-soiling benefits of the dried nanosilica-containing coating compositions applied to and dried on a PET substrate after being subjected to the Anti-soiling Test is shown by the photographs in FIGS. 6G (NPS5 alone), 6H (NPS1 alone) and 6J (the coating combination of NPS1 and NPS5 as described above).

### Example 122

This Example was prepared and tested following the same procedures as described for Example No. 116, except that the nanosilica-containing coating composition used in this Example was an aqueous dispersion formed by combining NPS2 (5 nm) and NPS5 (20 nm) silica nanoparticle dispersions at a weight ratio of 30 to 70, and a solids content of 10 wt %, and acidifying with HCl. The coating composition was applied to the bottom half of a glass substrate, and to the bottom half of a PET substrate. In addition, a coating composition including only NPS2, and another coating composition including only NPS5, were each applied separately to the bottom half of a glass substrate, and to the bottom half of a PET substrate.

The anti-soiling benefits of the dried nanosilica-containing coating compositions applied to and dried on a glass substrate after being subjected to the Anti-soiling Test is shown by the photographs in FIG. 6A (NPS5 alone), FIGS. 6C (NPS2 alone), and 6E (the coating combination of NPS2 and NPS5 as described above). The anti-soiling benefits of the dried nanosilica-containing coating compositions applied to and dried on a PET substrate after being subjected to the Anti-soiling Test is shown by the photographs in FIGS. 6G (NPS5 alone), 6I (NPS2 alone) and 6K (the coating combination of NPS1 and NPS5 as described above).

### Example 123

This Example was prepared and tested following the same procedures as described for Example No. 116, except that the nanosilica-containing coating composition used in this Example was an aqueous dispersion formed by combining NPS1 (4 nm) and TX11561 silica nanoparticle dispersions at a weight ratio of 70 to 30, and a solids content of 10 wt. %, and acidifying with HCl. The coating composition was applied to the bottom half of a glass substrate, and to the bottom half of a PET substrate.

The anti-soiling benefits of the dried nanosilica-containing coating compositions applied to and dried on a glass substrate after being subjected to the Anti-soiling Test is shown by the photographs in 6F (showing the coating combination of NPS1 and TX11561 as described above). The anti-soiling properties of the dried nanosilica-containing coating compositions applied to and dried on a PET substrate after being subjected to the Anti-soiling Test is shown by the photographs in FIG. 6L (showing the coating combination of NPS1 and TX 11561 as described above).

### Example 124

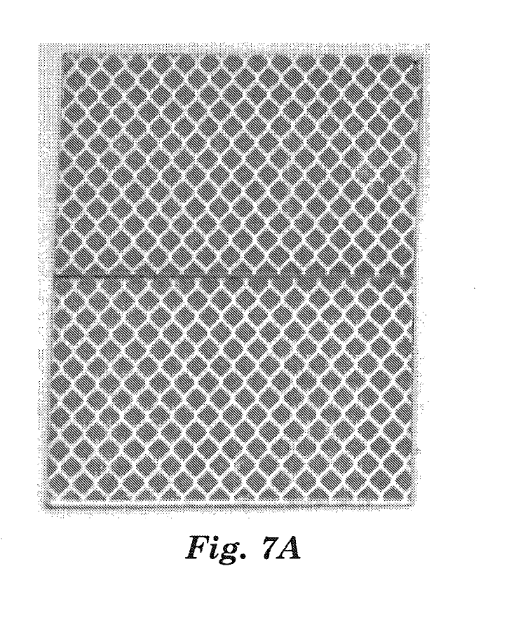

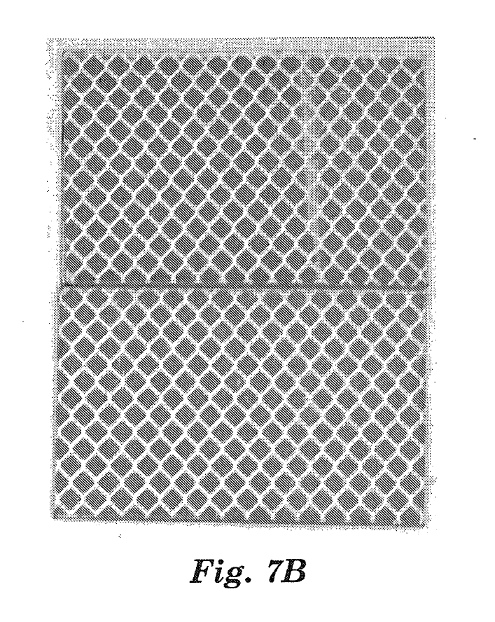

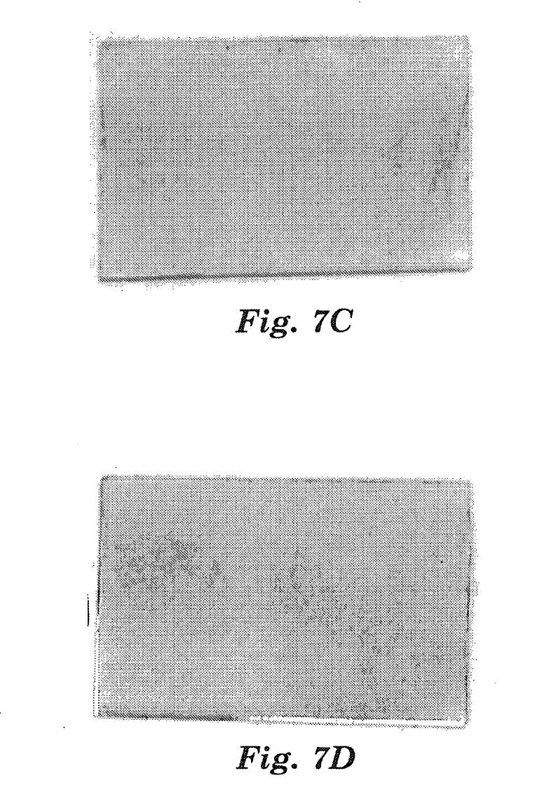

Example 124 demonstrates the anti-soiling benefits of an exemplary retro-reflective polymethylmethacrylate (PMMA) (co)polymer film substrate coated with an exemplary nanosilica-containing coating composition of the present disclosure, after application of the anti-soiling test described herein. Example 124 was prepared as Example 116 except that the substrate was TP15 and the aqueous dispersion was NPS5: NPS1 in a ratio of 90:10. The comparative anti-soiling characteristics are shown in FIGS. 7A-7D. The top retro-reflective PMMA substrates (FIGS. 7A-7B) were coated with the exemplary nanosilica-containing coating composition, while the lower retro-reflective PMMA substrates (FIGS. 7C-7D) were not coated.

### Example 125

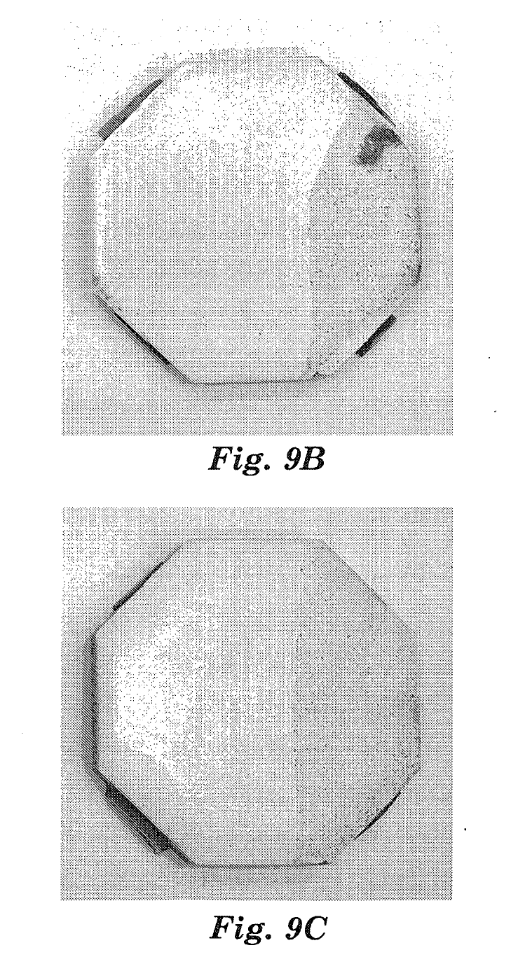

Example 125 demonstrates the anti-soiling benefits of an exemplary nanosilica-containing coating composition of the present disclosure when applied to an exemplary polyvinyl chloride (PVC) sheet, after application of the Anti-soiling Test described herein. Example 125 was prepared as Example 116 with the exceptions that the substrate was TP12, the aqueous nanoparticle dispersion was 10 wt. % NPS1:PU1 in a ratio of 90:10, and the coating was applied using a #6 Meyer bar. A lower portion of the (co)polymer film substrate was coated with the exemplary nanosilica-containing coating composition according to the present disclosure, and an upper portion of the glass substrate was an uncoated control. The comparative anti-soiling characteristics are shown in FIG. 9A.

D. Coating Compositions Applied to Light Transmissive Substrates

### Example 126

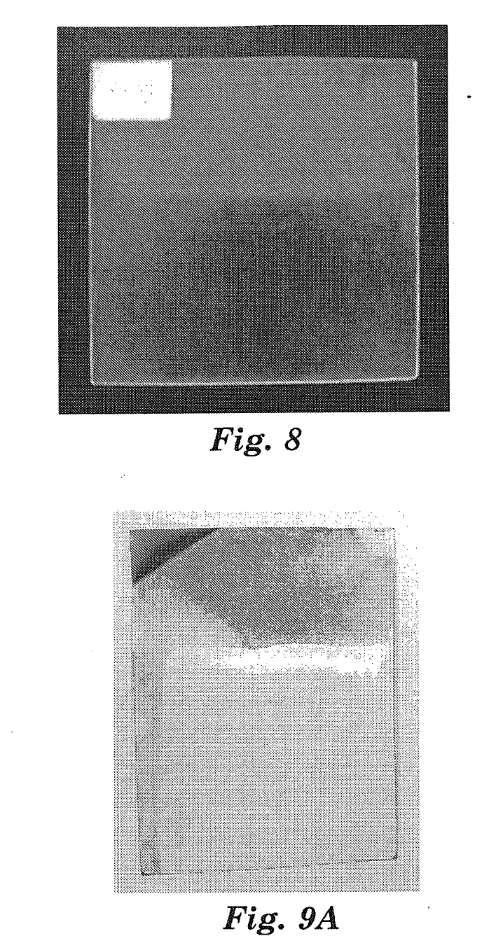

Example 126 demonstrates the anti-soiling benefits of an exemplary nanosilica-containing coating composition of the present disclosure when applied to the glass substrate of a photovoltaic solar cell, after application of the Anti-soiling Test described herein. Example 126 was prepared as Example 116, except that the substrate was TP16 and the aqueous nanoparticle dispersion was NPS5:NPS1 in a ratio of 70:30. A lower portion of the glass substrate was coated with the exemplary nanosilica-containing coating composition according to the present disclosure, and an upper portion of the glass substrate was an uncoated control. The comparative anti-soiling characteristics are shown in FIG. 8.

### Example 127

Example 127 demonstrates the efficacy of the inventive coatings to withstand weathering to resist soiling and maintain Total Solar Reflection. Sufficient TP18 roof coating material was transferred to a rectangular Teflon well having dimensions of 2 mm×610 mm×300 mm to cover the well. The surface was smoothed by a Teflon™ bar by moving the bar from one end to another against the edge of well. The wet film was left under a fume hood for 3 days. The resulting white elastomeric substrate was then removed from the well and cut to obtain a 150 mm×250 mm test substrate. A 50:50 (based on solids) blend of NPS1 and NPS5 was prepared to produce a 10 weight percent test dispersion.

The test dispersion was uniformly brushed onto the test substrate using a 15 mm polyester brush. The coated specimen was air-dried for 3 minutes, dried in an oven set at 100 degrees C. for 10 minutes, and then allowed to cool to room temperature. The coated specimen was then cut into 30 mm×150 mm specimens for the Weathering Test. Following soiling; each test specimen was evaluated for TSR.

### Example 128

Example 128 was prepared identically to Example 127 with the exception that the blend of NPS1 and NPS5 was changed to 70:30 (based on solids).

Total Solar Reflection for Example 128 and Example 129 are shown at various weathering times in Table 15.

TABLE 15

| | |
|---|---|
| Weathering | TSR (%) after Soiling Test |

| time (hr) | Example 128 | Example 129 |
|---|---|---|
| 0 | 74.3 | 77.2 |
| 336 | 78.2 | 81.2 |
| 667 | 74.7 | 75.5 |
| 1008 | 73.2 | 71.1 |

D. Coating Compositions Applied to Ceramic Substrates

### Example 129

Example 129 demonstrates the anti-soiling benefits of an exemplary nanosilica-containing coating composition of the present disclosure when applied to an exemplary ceramic tile surface. Example 129 was prepared as Example 116 with the exceptions that the substrate was TP17 and the aqueous nanoparticle dispersion was NPS1:NPS5 in a ratio of 1:1. The left two-thirds of each ceramic substrate was coated with the exemplary nanosilica-containing coating composition according to the present disclosure, and the right third of each ceramic substrate was an uncoated control. The comparative anti-soiling characteristics are shown in FIGS. 9B-9C.

E. Coating Compositions Applied to Roof Coating Substrates

Examples 130 through 136 and Comparative Examples 18-21 were prepared to demonstrate the efficacy of the inventive coatings when applied to substrates comprising exemplary SCOTCHKOTE roof coating materials from 3M Company, St. Paul, Minn., which when substantially cured, form exemplary white roof coating substrates. Each roof coating substrate was prepared by filling a rectangular TEFLON well having dimensions of 2 mm×610 mm×300 mm with sufficient uncured TP18 or TP19 roof coating material to fill the well, then the surface was smoothed by a TEFLON bar by moving the bar from one end to another against the upper edges of the walls defining the well. The wet film of uncured roof coating material in the well was allowed to cure in a fume hood for three days until substantially cured, at which time the white elastomeric roof coating substrate was removed from the well.

### Example 130

To a pre-cut 75 mm×250 mm sample of TP18, a 10 wt. % solids blend of 90 parts NPS5 and 10 parts PU1 at pH 9 was applied as uniformly as possible to the surface of the substrate using a 15 mm wide polyester brush. After the coating was cured on the substrate in air for 48 hrs, the coated substrate was cut into about 20 mm×25 mm rectangular pieces, which were then subjected to the Anti-soiling Test and Total Solar Reflection measurement.

### Example 131

Example 131 was prepared identically to Example 130, except that NPS4 was substituted for NPS5.

### Example 132

Example 132 was prepared identically to Example 130, except that PA4 was substituted for PU1.

### Example 133

Example 133 was prepared identically to Example 130, except that NPS4 was substituted for NPS5 and PA4 was substituted for PU1

### Comparative Example 18

Comparative Example 18 was prepared identically to Example 130, except that no coating was applied to the substrate.

The TSR values of these Examples and Comparative Examples measured after application of the Anti-soiling Test are summarized in Table 16.

TABLE 16

| Example | Substrate | Coating Composition | TSR (%) |
|---|---|---|---|
| Comparative Ex. 18 | TP18 | NONE | 39.6 |
| Example 130 | TP18 | NPS5/PU1 | 78.4 |
| | | (90/10) | |
| Example 131 | TP18 | NPS4/PU1 | 76.2 |
| | | (90/10) | |
| Example 132 | TP18 | NPS5/PA4 | 72.6 |
| | | (90/10) | |
| Example 133 | TP18 | NPS4/PA4 | 76.9 |
| | | (90/10) | |

### Substrate Conditioning Procedures:

### Hot Soaking Procedure

A piece of coated substrate was submerged in about 150 ml of water and maintained at 95° C. in an oven. After the specimen was soaked for 2 hr, 4 hr, or 20 hr, it was removed from the hot water and allowed to dry at ambient conditions overnight.

### Boiling Procedure

A piece of coated substrate was submerged in about 150 ml of boiling water. After the sample was maintained in boiling water for 2 or 4 hrs, it was removed from the boiling water and allowed to dry at ambient conditions overnight.

### Ultrasonic Exposure Procedure

A piece of coated substrate was placed into an Ultrasonic Bath Cleaner (BRANSON B-32 Ultrasonic Bath, Branson Ultrasonics Corp., Danbury, Conn.) containing about 750 ml of water. After the sample was ultrasonicated for 20 minutes, it was removed from the water and allowed to dry at ambient conditions overnight.

### Example 134

Example 134 was prepared and tested in the same way as described for Example 130, except that TP19 was coated with a 10 wt % dispersion of a 1/1 mixture of NPS4/FM1 instead of the NPS4 coating.

### Example 135

Example 135 was prepared identically to Example 134, except that TP18 was substituted for TP19 and the composition of the NPS4/FM1 mixture was changed to 3/1.

### Comparative Example 19

To a pre-cut approximate 75 mm×250 mm TP18 specimen, 1.73 g of a NPS4 dispersion diluted to 10% by weight (with deionized water containing 0.09 wt % sodium dodecyl sulfate) was applied as uniformly as possible using a 15 mm wide polyester brush. After the coating was dried at ambient conditions for 48 hrs, it was cut into approximate 75 mm×40 mm rectangular samples for further conditioning using the Hot Soaking Procedure, the Boiling Procedure, or the Ultrasonic Exposure Procedure. Upon the completion of each procedure, the samples were air dried under ambient conditions overnight. The Anti-soiling Test and TSR measurements were carried out on each sample.

### Comparative Example 20

Comparative Example 20 was prepared and tested in the same way as described for Comparative Example 19 except that TP19 was coated with a 10 wt. % dispersion of FM1 (diluted from original 15 wt. % using DI water and having 0.08 wt % of sodium dodecyl sulfate) instead of the NPS4 coating.

### Comparative Example 21

Comparative Example 21 was prepared and tested in the same way as described for Comparative Example 19, except that the NPS4 dispersion was coated onto TP18 instead of TP19.

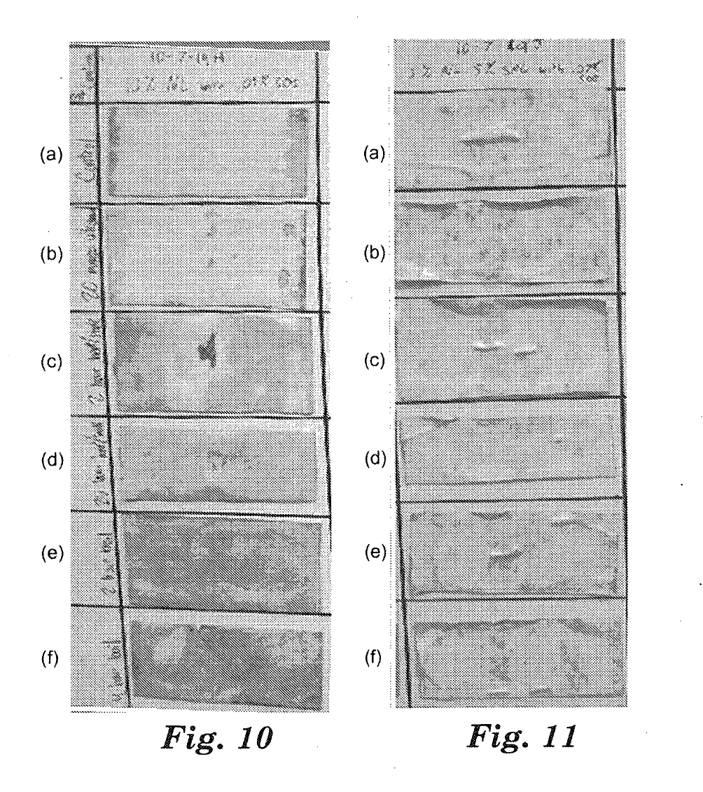

The TSR values of these Examples and Comparative Examples after the foregoing Substrate Conditioning Procedures were applied and the Anti-soiling Test was conducted are summarized in Table 17 and FIGS. 10-14.

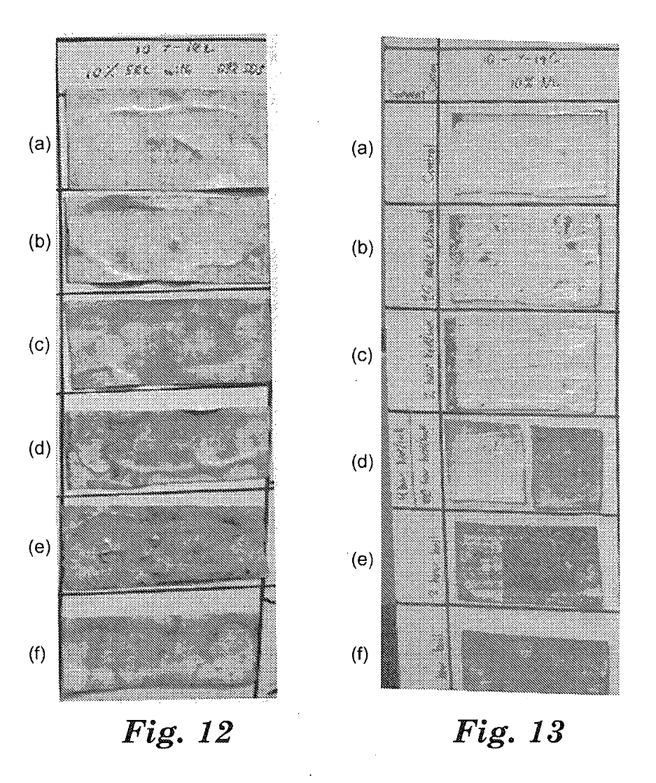

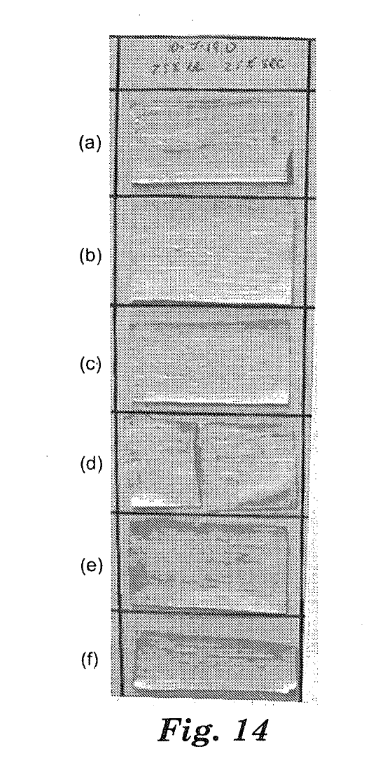

TABLE 17

| | TSR, % | | | | | | |
|---|---|---|---|---|---|---|---|
| | | Ultrasonic | Hot | Hot | Hot | | |
| | | Exposure | Soaking | Soaking | Soaking | Boiling | Boiling |
| | CONTROL | Procedure | Procedure | Procedure | Procedure | Procedure | Procedure |
| Example | No Treatment | (20 min) | (2 hr) | (4 hr) | (20 hr) | (2 hr) | (4 hr) |
| Comparative | 76.5 | 75.8 | 65.3 | n.d² | 62.3 | 56.6 | 56.7 |
| Ex. 19 | FIG. 10(a) | FIG. 10(b) | FIG. 10(c) | | FIG. 10(d) | FIG. 10(e) | FIG. 10(f) |
| Comparative | 71.6 | 70.5 | 60.9 | n.d. | 58.4 | 56.6 | 63.5 |
| Ex. 20 | FIG. 12(a) | FIG. 12(b) | FIG. 12(c) | | FIG. 12(d) | FIG. 12(e) | FIG. 12(f) |
| Example | 73.3 | 71.9 | 75.6 | n.d. | 71.1 | 70.5 | 72.5 |
| 135 | FIG. 11(a) | FIG. 11(b) | FIG. 11(c) | | FIG. 11(d) | FIG. 11(e) | FIG. 11(f) |
| Comparative | 77.8 | 78.9 | 74.0 | 65.9 | 50.7 | 43.8 | 50.0 |
| Ex. 21 | FIG. 13(a) | FIG. 13(b) | FIG. 13(c) | | FIG. 13(d) | FIG. 13(e) | FIG. 13(f) |
| Example | 78.1 | 80.9 | 80.7 | 78.8 | 74.4 | 71.5 | 72.1 |
| 136 | FIG. 14(a) | FIG. 14(b) | FIG. 14(c) | | FIG. 14(d) | FIG. 14(e) | FIG. 14(f) |

²n.d. = not determined

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g. 1 to 5 includes 1, 1.5, 2, 2.75, 3, 3.80, 4, and 5). In addition, all numbers used herein are assumed to be modified by the term ‘about’. Furthermore, all publications, published patent applications and issued patents referenced herein are incorporated by reference in their entirety as needed to provide support for the presently claimed invention and to the same extent as if each individual publication or patent was specifically and individually indicated to be incorporated by reference. Various exemplary embodiments have been described. These and other embodiments are within the scope of the following claims.

1. A method of providing a coating to a substrate comprising:
a) contacting a light reflective surface of a substrate with an aqueous coating composition comprising water, silica nanoparticles having a mean particle diameter of 40 nanometers or less dispersed in the water, and an acid having a pKa of <3.5 in an amount effective to produce a pH of less than 5; and
b) removing at least a portion of the water to provide a dried silica nanoparticle coating on the light reflective surface of the substrate.

2. A method of providing a coating to a substrate comprising:
a) contacting a light reflective surface of a substrate with an aqueous coating composition comprising 0.5 to 99 wt. % water, 0.1 to 20 wt. % silica nanoparticles having a mean particle diameter of 20 nm or less, 0.1 to 60 wt. % silica nanoparticles having a mean particle diameter of from 20 nm to 200 nm, wherein the concentration of silica nanoparticles is from 0.2 to 80 percent by weight of the total composition, an acid having a pKa of <3.5 in an amount effective to produce a pH of less than 5, and optionally, 0 to 20 wt. % of a tetraalkoxysilane, relative to the total amount of the silica nanoparticles; and
b) removing at least a portion of the water to provide a dried silica nanoparticle coating on the light reflective surface of the substrate.

3. A method of providing a coating to a substrate comprising:
a) contacting a light reflective surface of a substrate with an aqueous coating composition comprising an aqueous continuous liquid phase, an acid having a pKa of <3.5 in an amount effective to produce a pH of less than 5; and core-shell particles dispersed in the aqueous continuous liquid phase, each core-shell particle comprising a dispersed (co)polymer core surrounded by a shell consisting essentially of silica nanoparticles disposed on the dispersed (co)polymer core, wherein the silica nanoparticles have a volume average particle diameter of 100 nanometers or less; and
b) removing at least a portion of the water to provide a coating of the dispersed (co)polymer and silica nanoparticles on the light reflective surface of the substrate.

4. The method of claim 1, wherein the acid is selected from oxalic acid, citric acid, H₃PO₄, HCl, HBr, HI, HBrO₃, HNO₃, HClO₄, H₂SO₄, CH₃SO₃H, CF₃SO₃H, CF₃CO₂H, and CH₃SO₂OH.

5. A method of providing a coating to a substrate comprising:
a) contacting a light reflective surface of a substrate with an aqueous coating composition comprising water, silica nanoparticles having a mean particle diameter of 40 nanometers or less dispersed in the water, and at least one dispersed (co)polymer, wherein the aqueous coating composition has a pH of at least 5; and
b) removing at least a portion of the water to provide a dried coating of the dispersed (co)polymer and silica nanoparticles on the light reflective surface of the substrate.

6. The method of claim 1, wherein a weight ratio of a total amount of the silica nanoparticles in the composition to a total amount of the at least one dispersed (co)polymer in the composition is in a range of from 85:15 to 95:5.

7-8. (canceled)

9. The method of claim 1, wherein the aqueous coating composition comprises no more than about 20% by weight of organic solvent.

10. The method of claim 1, wherein the aqueous coating composition is substantially free of organic solvent.

11. The method of claim 1, wherein the aqueous coating composition further comprises at least one miscible (co)polymer.

12. The method of claim 1, wherein the dried silica nanoparticle coating on the light reflective surface of the substrate increases the reflectivity of the surface.

13. (canceled)

14. The method of claim 13, wherein the substrate comprises a (co)polymer selected from poly(vinyl chloride), polyolefins, polycarbonates, polyamides, polyimides, polystyrenes, polyurethanes, polyesters, poly(ethylene terephthalate) (PET), flame-treated PET, cellulose diacetate, cellulose triacetate, styrene-acrylonitrile copolymers, styrene-(meth)acrylate copolymers, ethylene-propylene dimer rubbers, phenolic resins, and combinations thereof.

15. The method of claim 1, wherein the substrate comprises a reflective (co)polymer film.

16. The method of claim 1, wherein, the substrate is transparent to visible light.

17. The method of claim 1, wherein the dried silica nanoparticle coating on the light reflective surface of the substrate exhibits a static water contact angle of less than 50°.

18. The method of claim 1, wherein the dried silica nanoparticle coating on the light reflective surface of the substrate is from about 50 to about 250 nm thick.

19. The method of claim 1, wherein the concentration of the silica nanoparticles is from 0.1 to 20 percent by weight of the coating composition.

20. The method of claim 1, wherein the silica nanoparticles are non-spherical.

21. The method of claim 1, wherein the composition further comprises a surfactant.

22. (canceled)

23. A construction article made by the method of any preceding claim, wherein the substrate is selected from the group consisting of architectural glass, ceramic tiles, cement, stone, concrete, masonry, brick, porcelain, a painted surface, wood, architectural siding, decking materials, decorative or protective polymeric films, polymeric construction adhesives, sheet molding compounds, roofing materials, and combinations thereof.

24. (canceled)

25. The construction article of claim 23, wherein the substrate is a roof coating comprising at least one (co)polymer selected from the group consisting of a styrene-(meth)acrylic copolymer, a polyurethane (co)polymer, an ethylene-propylene dimer elastomer, a chlorinated polyethylene elastomer, a chlorosulfonated polyethylene elastomer, an acrylonitrile rubber, a poly(isobutylene) elastomer, a thermoplastic polyolefin elastomer, a polyvinyl chloride elastomer, and combinations thereof.

26. (canceled)
